(19) United States
(12) Patent Application Publication
(10) Pub. No.: US 2026/0292281 A1
(43) Pub. Date: Sep. 24, 2026

(54) METHODS AND APPARATUS TO MONITOR TELEVISION ADVERTISING

(71) Applicant: DIRECTV, LLC, El Segundo, CA (US)

(72) Inventors: Surendiran Dhayala Rajan, Yorba Linda, CA (US); Suroor Wizarath Ali, Downey, CA (US); Snehalatha Munnangi, Torrance, CA (US); Matt Van Houten, Manhasset, NY (US); Eduardo Samame, Darien, CT (US)

(21) Appl. No.: 19/088,770

(22) Filed: Mar. 24, 2025

(51) Int. Cl. H04N 21/24; H04N 21/81

(52) U.S. Cl. CPC H04N 21/2407; H04N 21/812

(57) ABSTRACT

Disclosed examples include accessing a television network identifier in a first command from the remote service; sending a second command to a television media access client, the second command to include the television network identifier; accessing logged advertisement information generated by the television media access client, the logged advertisement information based on the television media access client accessing a television network corresponding to the television network identifier; and after performing a verification process on the logged advertisement information, sending the logged advertisement information to the remote service.

### FIELD OF THE DISCLOSURE

This disclosure relates generally to media distribution systems and, more particularly, to methods and apparatus to monitor television advertising.

### BACKGROUND

In media distribution systems such as television broadcast systems and on-demand media services, advertisements can be delivered with content. Upon receiving a media stream, a media presentation device can present the content and the advertisements during breaks in the content. In this manner, when audience members access the content, this creates an opportunity to also present advertisements to those audience members.

### BRIEF DESCRIPTION OF THE DRAWINGS

FIG. 1 is a block diagram of an example environment in which an example automation client computer monitors dynamic advertisement selection for advertisement breaks in media streams.

FIG. 2 shows an example ad-monitor automation client in communication with the set-top-box of FIG. 1 and an ad-monitor automation cloud-based service.

FIG. 3 is a block diagram of an example implementation of the ad-monitor automation client of FIG. 2.

FIG. 4 is a block diagram of an example implementation of the ad-monitor cloud-based service of FIG. 2.

FIGS. 5A and 5B include a flowchart representative of example machine-readable instructions and/or example operations that may be executed, instantiated, and/or performed by example programmable circuitry to implement the ad-monitor automation client of FIG. 3.

FIG. 6 is a flowchart representative of example machine-readable instructions and/or example operations that may be executed, instantiated, and/or performed by example programmable circuitry to implement the ad-monitor cloud-based service of FIG. 4.

FIG. 7 is a block diagram of an example processing platform including programmable circuitry structured to execute, instantiate, and/or perform the example machine readable instructions and/or perform the example operations of FIGS. 5A and 5B and/or FIG. 6 to implement the ad-monitor automation client of FIG. 3 and/or the ad-monitor cloud-based automation client of FIG. 4.

FIG. 8 is a block diagram of an example software/firmware/instructions distribution platform (e.g., one or more servers) to distribute software, instructions, and/or firmware (e.g., corresponding to the example machine readable instructions of FIGS. 5A, 5B, and 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Examples disclosed herein may be used to monitor advertisement activities using an advertisement (ad) monitor automation client that interacts with a set-top-box (STB) (e.g., connected to a content stream environment) to monitor presentations of ads placed using a dynamic advertisement insertion (DAI) system. The DAI system operates in the content stream environment in which different tier-level advertisements (ads) are used. In examples disclosed herein, tier-level advertisements include Tier-3 (T3) level advertisements, Tier-2 (T2) level advertisements, and Tier-1 (T1) level advertisements. Each of the T3-level, T2-level, and T1-level ads has a different level of relevancy to audiences of programming content. For example, as described in detail below, a T3-level ad (e.g., a T3-level ad creative) is generally relevant to an audience based on characteristics of concurrently presented programming content, a T1-level ad (e.g., a T1-level ad creative) is regionally relevant based on an audience's geographic region, and a T2-level ad (e.g., a T2-level ad creative) is user-level and/or household-level relevant to an audience member.

As used herein, programming content, or content, refers to primary media in a stream or broadcast such as television shows, program episodes, movies, news, music, etc. As used herein, an advertisement is secondary media in the stream or broadcast presented at different time allocations between segments of primary media in a corresponding media stream. Purchasers (e.g., manufacturers, retailers, service providers, political parties, etc.) of advertisement time pay an agreed upon price for ad spots and/or ad impressions in media streams. Such financial payments can be used by media networks to support or sponsor delivery of the programming content in the media streams.

Examples disclosed herein may be used to implement a network-based feedback tool to verify that purchasers'advertisements were presented in media streams as intended and to generate alerts/notifications about ad-selection and/or ad-presentation issues. Such verifications can also be used to correct how computing systems in a distributed media delivery system perform ad-selection and/or ad-presentation processes. In addition, such verifications can be used to reassure purchasers that their advertisements are being presented and properly placed for a target audience. An example ad-monitor automation client disclosed herein monitors presentations and placements of T2-level ads (e.g., DAI ads) which are dynamically inserted in media streams at STBs using a DAI system. For example, an ad-monitor automation client is connected to a STB and controls the STB to stream or tune to different channels that are DAI enabled. The STB creates logs of presented T2-level ads and sends the logged advertisement information (e.g., logged ad-monitoring information, ad impression logs) to the ad-monitor automation client for subsequent parsing based on key performance indicators (KPIs). The KPIs can be used to verify whether T2-level ads are presented to audience members as intended by corresponding purchasers of ad spots. In examples disclosed herein, the ad-monitor automation client is in communication with a cloud-based ad-monitor service through which a user can control the ad-monitoring activities of the ad-monitor automation client.

Examples disclosed herein improve the overall quality of advertising services for both advertisers and viewers (e.g., subscribers of media delivery services) by monitoring T2-level ad presentations using advertisement KPIs. Examples disclosed herein can be used to measure quality of service and provide automated certifications that T2-level ads are being presented using DAI in manners that satisfy agreements with purchasers of ad spots. By using an ad-monitor automation client that is separate from a STB, examples disclosed herein can be adapted and onboarded relatively quickly to monitor existing STBs and different types of STBs without needing to re-design such STBs.

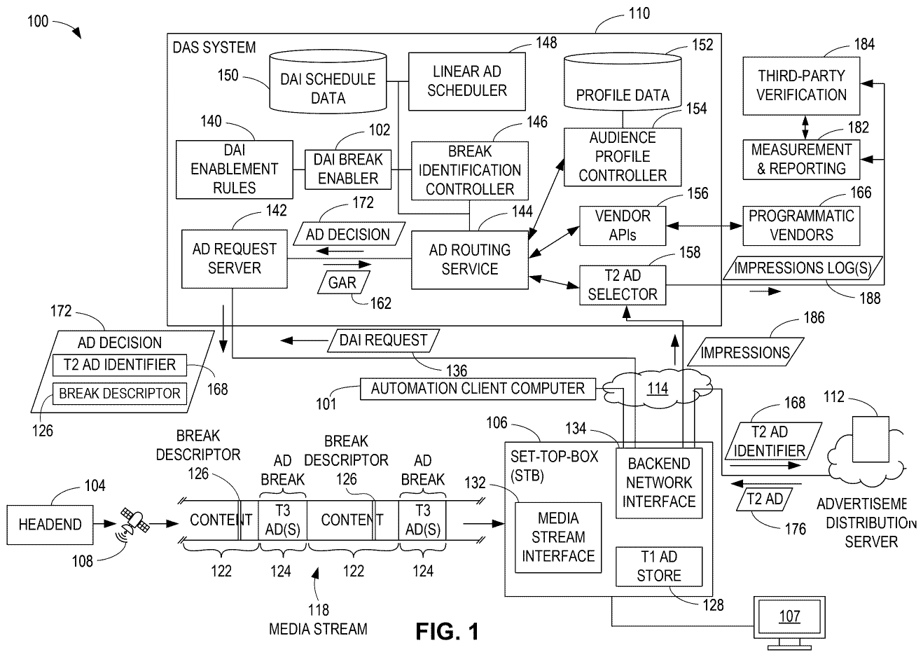

FIG. 1 is a block diagram of an example media distribution system 100 in which an example automation client computer 101 monitors presentations of advertisements dynamically inserted in advertisement breaks in media streams. The media distribution system 100 includes an example dynamic advertisement insertion (DAI) break enabler 102 that operates to enable dynamic ad selection for the ad breaks in the media streams. The media distribution system 100 includes an example headend system 104 in communication with a set-top-box (STB) 106 via a media distribution network such as a satellite network 108 or any other suitable type of media distribution network. The media distribution system 100 also includes an example dynamic ad selection (DAS) system 110 and an example advertisement distribution server 112 (e.g., a network resource) in communication with the STB 106 via a wide-area network (WAN) or a global network such as the Internet 114.

In examples disclosed herein, the headend system 104 generates media streams for delivery to the STB 106, and the STB 106 presents the media streams at an audience location of the STB 106. For example, the STB 106 is connected to an example television or video monitor 107 and sends display information (e.g., video data, image data, text data, etc.) to the television or video monitor 107 to present the media streams. In examples disclosed herein, the STB 106 is an example of a television media access client. A television media access client is programmable circuitry and/or software/firmware implemented in a device separate from the television 107 and connected to the television 107 or programmable circuitry and/or software/firmware implemented in the television 107. A television media access client communicates with a headend system (e.g., the headend system 104) to access/receive the media stream 118 and present the media stream 118 via the television 107. Although examples disclosed herein are described relative to the STB 106, examples disclosed herein may be implemented using any television media access client that accesses a headend system to access a media stream regardless of whether the television media access client is a device separate from the television 107 or implemented in the television 107.

Also in examples disclosed herein, the DAS system 110 includes the DAI break enabler 102 to enable dynamic ad selection for ad breaks in the media streams. Upon enablement of dynamic ad selection by the DAI break enabler 102, the DAS system 110 also selects ads based on user-level profile information and/or household-level profile information to be presented by the STB 106. Also in examples disclosed herein, the advertisement distribution server 112 stores advertisements selected by the DAS system 110. After the STB 106 receives a selected ad identifier (ad ID) from the DAS system 110, the STB 106 uses a uniform resource locator (URL) of the advertisement distribution server 112 to send the ad identifier to the advertisement distribution server 112 to retrieve the ad corresponding to the selected ad identifier. In examples disclosed herein, an ad ID uniquely identifies a corresponding advertisement at the advertisement distribution server 112. In some examples, the advertisement distribution server 112 may be implemented using a cloud-based content distribution network (CDN).

The STB 106 is at a subscriber location (e.g., a residence, a business, a school, etc.). The headend system 104 transmits an example media stream 118 to the STB 106. The media stream 118 is a substantially real-time feed that includes example content segments 122 and example ad break segments 124. The content segments 122 include programming content such as television shows, program episodes, movies, news, music, etc. The ad break segments 124 are provided to present ads via the STB 106. The media stream 118 also includes example break descriptors 126 (e.g., break text descriptors) co-located with the content segments 122 in a manner that the break descriptors 126 are not perceivable by an audience of the media stream 118. Each break descriptor 126 includes a unique ad break identifier that uniquely identifies a corresponding one of the ad breaks 124 that is upcoming in the media stream 118.

The headend system 104 inserts T3-level advertisements in the advertisement breaks 124 of the media stream 118. In examples disclosed herein, T3-level advertisements are linear advertisements in that they are scheduled with corresponding content programming and transmitted in line with the media stream 118 by the headend system 104. As used herein, T3-level advertisements are not targeted based on individual audience profiles but are deemed generally relevant to audiences expected to tune in to concurrently scheduled programming content. For example, if the content 122 includes a prime-time news stream, the corresponding ad breaks 124 will include T3-level ads relevant to an audience interested in the prime-time news stream. That is, the T3-level ads are scheduled linearly with the prime-time news stream based on characteristics of the prime-time news stream and a general audience to which those characteristics appeal instead of user-level or household-level characteristics of individual audience members.

In the example of FIG. 1, the headend system 104 provides T1-level ads to the STB 106 in advance of media streams with which the T1-level ads are to be presented. The STB 106 includes an example T1-level ad store 128 that stores the T1-level ads. For example, the T1-level ad store 128 can store multiple T1-level ads from which the STB 106 can select to present in place of or as substitutes for the linear T3-level ads populated in the media stream 118 at the headend system 104. T1-level ads are more-targeted advertisements that have a greater level of relevancy to audiences at corresponding STBs based on geographic regions of those audiences. For example, T1-level ads are STB-addressable ads that can be targeted on a per-region basis to particular STBs (e.g., based on their respective network addresses). As such, a T1-level ad could be distributed in a manner that makes it geographically relevant to an audience in a particular region in which a STB is located. For example, T1-level ads could be used to advertise for local businesses in a geographic region.

When signaled by the headend system 104, the STB 106 may replace or overlay a T3-level ad at an ad break 124 with a locally queued T1-level ad from the T1 ad store 128. The STB 106 can select a locally queued T1-level ad based on one or more locally enforced rules. For example, the STB 106 may refer to locally stored rules about frequency of presentation (e.g., over-presented or under-presented) for different T1-level ads, times of day of when to present T1-level ads, etc.

In examples disclosed herein, the STB 106 includes an example media stream interface 132 and an example backend network interface 134. The media stream interface 132 connects the STB 106 to the headend system 104 via the satellite network 108. The backend network interface 134 connects the STB 106 to an example DAS system 110 via a wide-area network (WAN) or a global network such as the Internet 114. In example FIG. 1, the DAS system 110 is a backend system separate from the headend system 104. For example, the headend system 104 delivers the media stream 118 and default linear T3-level advertisements to the STB 106 via a first network (e.g., the satellite network 108) and the DAS system 110 delivers ad decisions (e.g., the ad decision 172) on dynamic ad selection of T2-level ads to the STB 106 via a separate, second network (e.g., a WAN or the Internet 114).

During receipt of the media stream 118 at the STB 106 from the headend system 104 via the media stream interface 132, the STB 106 sends an example DAI request message 136 to the DAS system 110 via the backend network interface 134. The DAI request 136 causes the DAS system 110 to determine whether to enable dynamic ad selection of a T2-level ad for an upcoming one of the ad breaks 124 in the media stream 118. By enabling or disabling dynamic ad selection of a T2-level ad at the DAS system 110 for an ad break 124 in the media stream 118, a third type of advertisement selection technology may be provided. For example, while T3-level ads are deemed generally relevant to an audience based on characteristics of the content 122 and T1-level ads can be targeted based on a geographic region of the STB 106, T2-level ads can be selected based on user-level profiles and/or household-level profiles of audience members. For example, the DAS system 110 can store user-level audience profile information (and/or household-level audience profile information) such as demographics, media preferences, product preferences, and media access histories (e.g., viewing histories) specific to audience members associated with different STBs. In this manner, the DAS system 110 can select a T2-level ad that is substantially more user-level relevant and/or household-level relevant to an audience (e.g., one or more audience members) than a T3-level ad or a T1-level ad. In addition, selection of a T2-level ad at the DAS system 110 allows reducing the storage capacity of the T1 ad store 128 used at the STB 106 to store T1-level ads and allows reducing the amount of network bandwidth used to periodically update the locally stored T1-level ads at the STB 106. For example, more T2-level ads can be stored at a network resource (e.g., the advertisement distribution server 112) and updated more frequently at that network resource without using large amounts of network capacity to pre-download the ads to the numerous STBs leased out by a media network operator.

To enable and perform dynamic ad selection, the DAS system 110 includes multiple subsystems. For example, the DAS system 110 includes the example DAI break enabler 102, an example DAI enablement rules database 140, an example ad request server 142, an example ad routing service 144, an example break identification controller 146, an example linear ad scheduler 148, an example DAI schedule database 150, an example profile database 152, an example audience profile controller 154, example vendor application programming interfaces (APIs) 156, and an example T2 ad selector 158.

The ad request server 142 operates as an interface of the DAS system 110 to communicate with STBs such as the STB 106. For example, the ad request server 142 receives the DAI request 136 from the STB 106 via the Internet 114. After receipt of the DAI request 136, the ad request server 142 converts the DAI request 136 to an example general ad request (GAR) 162. As such, the ad request server 142 also operates as an ad request translation service to receive DAI requests in different formats from different STBs and to convert the received DAI requests into the GAR 162 in a format that can be processed by other subsystems of the DAS system 110.

The GAR 162 enables the ad routing service 144 to access requests from multiple different types of requesting entities (e.g., STBs associated with different media service providers), without burdening the ad routing service 144 with overhead associated with having to process information/data associated with the details of a particular type of requesting entity. In some examples, the GAR 162 includes three fields, referred to herein as: (1) a key, (2) a base object, and (3) an extension object. Each of these three fields may include parameters/sub-fields as described in further detail below.

The key may identify a particular requesting entity (e.g., the STB 106) and/or a particular vendor/service provider (e.g., the ad routing service 144). The base object may include one or more of: (1) a network identifier, (2) an application identifier, (3) a session identifier, (4) a platform identifier, (5) an address identifier (e.g., an Internet protocol (IP) address), (6) location coordinates, (7) an advertising type, (8) a stream identifier, and/or (9) a call back time parameter. The extension object may include: (1) an ad decision server (ADS) parameter (e.g., if the DAS system 110 does not derive the ADS from the key), and (2) one or more pass-through attributes. A pass-through attribute may include one or more parameters that may be used by the ad routing service 144 identified by the key. That is, the ad request server 142 may transfer pass-through attributes of the extension object in an unadulterated form, such as the break descriptors 126, from the STB 106 to the ad routing service 144.

The GAR 162 causes the DAS system 110 to determine whether to enable dynamic ad selection for an upcoming one of the ad breaks 124 in the media stream 118. For example, the DAI request 136 includes an audience identifier (e.g., a publisher-provided identifier (PPid)) associated with the STB 106 and one of the break descriptors 126 corresponding to an upcoming one of the ad breaks 124 in the media stream 118. The ad request server 142 places the audience identifier and the break descriptor 126 in the GAR 162. In response to the GAR 162, the ad routing service 144 provides the break descriptor 126 to the break identification controller 146. The break identification controller 146 identifies the upcoming ad break 124 in the media stream 118 based on the break descriptor 126. For example, the break descriptor 126 includes a break identifier indicative of the upcoming ad break 124.

The linear ad scheduler 148 provides linear ad schedules of the ad breaks 124 in the media stream 118 in which the headend system 104 inserts the default linear type T3-level ads. The linear ad schedules include dates and times during which the ad breaks 124 occur in the media stream 118 for the different television channels offered by the headend system 104. In some examples, the linear ad scheduler 148 obtains the linear ad schedules from the headend system 104. In other examples, the linear ad scheduler 148 obtains the linear ad schedules from one or more other parties (e.g., content providers of different television channels) that create the linear ad schedules and/or programming content schedules for the headend system 104. In yet other examples, users enter the linear ad schedule information into the linear ad scheduler 148 based on information received from the headend system 104 and/or other parties.

The DAI enablement rules database 140 is provided to store DAI enablement rules created by an ad scheduling team. The DAI enablement rules in the DAI enablement rules database 140 are indicative of which of the ad breaks 124 in the media stream 118 are to be enabled for dynamic ad selection (e.g., dynamic ad insertion). Examples of how rules are created in the DAI enablement rules database 140 are disclosed in U.S. patent application Ser. No. 18/811,523 and filed on Aug. 21, 2024, which is hereby incorporated herein by reference in its entirety.

The DAI break enabler 102 accesses ad schedule information corresponding to break identifiers in the DAI schedule database 150. The schedule information in the DAI schedule database 150 includes break identifiers of the different ad breaks 124. When a break descriptor 126 is received at the DAS system 110, the DAI break enabler 102 locates the break descriptor 126 in the schedule information and analyzes the schedule information relative to rules in the DAI enablement rules database 140. Based on this analysis, the DAI break enabler 102 determines whether to enable or disable dynamic ad selection (e.g., dynamic ad insertion) of a T2-level ad for a corresponding upcoming ad break 124 corresponding to the break descriptor 126 based on the DAI enablement rules.

The DAI break enabler 102 updates the DAI schedule database 150 to include a dynamic ad selection enable decision for the upcoming ad break 124. For example, if the DAI break enabler 102 determines that one or more rules in the DAI enablement rules database 140 indicates that a T2-level ad is to be presented for the ad break 124, the DAI break enabler 102 sets the corresponding tier-level indicator to a T2-level ad type in association with a break identifier of that ad break 124 in the DAI schedule database 150. This indicator setting in the DAI schedule database 150 allows for the enabling of dynamic ad selection of a T2-level ad for that ad break 124. In some examples, through this updating, the DAI break enabler 102 stores codes or values as T2 tier-level indicators in association with different ad breaks 124 to indicate the ad selection enable decision to present a T2 tier-level ad type during those ad breaks 124. The break identification controller 146 retrieves the dynamic ad selection enable decision from the DAI schedule database 150 and provides the dynamic ad selection enable decision to the ad routing service 144.

If the dynamic ad selection enable decision generated by the DAI break enabler 102 indicates that dynamic ad selection is enabled for the upcoming ad break 124, the ad routing service 144 obtains audience profile information from the audience profile controller 154 and obtains a T2 ad campaign identifier from a vendor API 156, as described below, so that the T2 ad selector 158 can select a T2-level ad to be presented by the STB 106 instead of (e.g., as a substitute for) the T3-level ad at the upcoming ad break 124. For example, the profile database 152 stores user-level audience profile information (and/or household-level audience profile information) such as demographics, media preferences, product preferences, and media access histories (e.g., viewing histories) specific to audience members associated with different STBs. The audience profile controller 154 uses the audience identifier received in the GAR 162 to access corresponding audience profile information associated with the STB 106 from the profile database 152 and provides the audience profile information to the ad routing service 144.

The ad routing service 144 generates an ad opportunity notification that includes the audience profile information associated with the STB 106 and sends the ad opportunity notification to the vendor APIs 156. In other words, the ad routing service 144 initiates/sends an ad server request (e.g., a FreeWheel ad request) corresponding to the GAR 162 to the vendor APIs 156. The ad opportunity notification, or ad server request, includes a transaction identifier of the current ad request and a STB device identifier (e.g., an address ID) of the STB 106. As used herein, a transaction identifier is a unique identifier ensuring that no two ad retrieval transactions have the same identifier. A transaction identifier identifies an ad retrieval transaction (e.g., based on an ad request and corresponding ad response) between the STB 106 and the DAS system 110. For example, the transaction identifier is associated with a corresponding GAR 162. In example FIG. 1, the vendor APIs 156 are instantiated in corresponding vendor servers to communicate with multiple example programmatic vendors 166. The programmatic vendors 166 are ad spot brokers that negotiate sales of available ad spot opportunities in media streams (e.g., the media stream 118) with potential ad spot purchasers (e.g., manufacturers, retailers, service providers, political parties, etc.).

In example FIG. 1, the programmatic vendors 166 provide the audience profile information from the ad opportunity notification to the potential ad spot purchasers. The potential ad spot purchasers can determine whether their ad campaigns align with an audience associated with the STB 106 based on the audience profile information. As such, the potential ad spot purchasers can purchase ad spots to target their advertisements at the user level for different audience members associated with different STBs. When an ad spot purchaser purchases an ad spot for the upcoming ad break 124, the ad spot purchaser selects one of its ad campaign identifiers corresponding to an ad campaign that aligns with the audience profile information. The ad campaign can include one or more ads relevant to the audience profile information. In some examples, the programmatic vendors 166 use auction systems for ad spot purchasers to bid on available ad spot opportunities based on audience profile information associated with STBs so that their corresponding advertisements are presented by the STBs.

After a programmatic vendor 166 finds an ad spot purchaser that agrees to purchase the ad spot corresponding to the upcoming ad break 124, a corresponding vendor API 156 reports the match between the ad spot purchaser and the upcoming ad break 124 to the ad routing service 144. The match reporting can include an ad campaign identifier from the ad spot purchaser. The ad routing service 144 sends the ad campaign identifier to the T2 ad selector 158. The T2 ad selector 158 selects a T2-level ad corresponding to the ad campaign identifier. For example, the T2 ad selector 158 may select the T2-level ad (e.g., a T2-level ad creative) based on one or more criteria such as time of day, frequency of presentation, duration since last selection, etc. The T2 ad selector 158 provides the ad routing service 144 an example T2-level ad identifier 168 corresponding to the selected T2-level ad. In some examples, the T2 ad selector 158 may be implemented by an ad selection service such as the Freewheel technology platform of New York, New York, United States of America.

The ad routing service 144 generates an example ad decision 172. For instances in which the DAI break enabler 102 enables dynamic ad selection for the upcoming ad break 124, the ad routing service 144 includes the T2-level ad identifier 168 and the break descriptor 126 in the ad decision 172, as shown in FIG. 1. Alternatively, for instances in which the DAI break enabler 102 does not enable dynamic ad selection for the upcoming ad break 124, the ad routing service 144 includes a code or value in the ad decision 172 indicative that the STB 106 is to present a T3-level ad or a T1-level ad for the upcoming ad break 124.

The ad routing service 144 provides the ad decision 172 to the ad request server 142, and the ad request server 142 sends the ad decision 172 to the STB 106 via the Internet 114. The STB 106 receives the ad decision 172 via the backend network interface 134. To present a selected T2-level ad at the upcoming ad break 124, the STB 106 sends the T2-level ad identifier 168 to the advertisement distribution server 112. The advertisement distribution server 112 retrieves one or more media file(s) for a T2-level ad 176 (e.g., a T2-level ad creative 176) corresponding to the T2-level ad identifier 168 and sends the media file(s) for the T2-level ad 176 to the STB 106. The STB 106 decodes the T2 ad media file(s) and presents the corresponding T2-level ad 176.

In example FIG. 1, the T2 ad selector 158 is in communication with an example measurement and reporting platform 182 and an example third-party verification platform 184. During or after ad presentations by the STB 106, the STB 106 reports corresponding impression notifications 186 to the T2 ad selector 158 via the Internet 114 using the backend network interface 134. As used herein, an impression is the occurrence of an ad presentation via a STB such as the STB 106. The impression is representative of an opportunity for one or more audience members to be exposed to the presented ad. The T2 ad selector 158 logs the impression notifications 186 in one or more impressions log(s) 188 and sends the impressions log(s) 188 to the measurement and reporting platform 182 and/or the third-party verification platform 184. The measurement and reporting platform 182 performs analytics on the impressions log(s) 188. The third-party verification platform 184 is a neutral third-party that confirms accuracies of the impressions reported in the impressions log(s) 188.

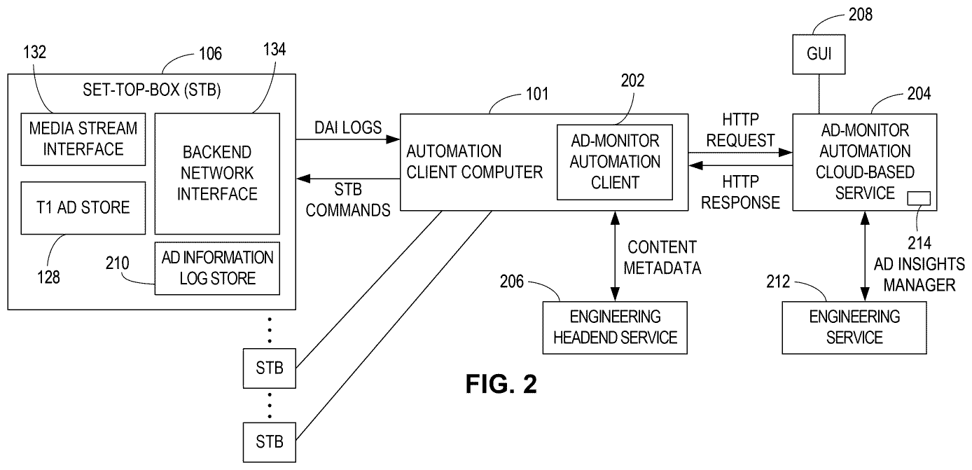

FIG. 2 shows an example ad-monitor automation client 202 in the automation client computer 101 of FIG. 1. The ad-monitor automation client 202 is in communication with the STB 106 (e.g., a television media access client) of FIG. 1, in communication with an example ad-monitor automation cloud-based service 204, and in communication with an example engineering headend service 206. For example, the automation client computer 101 may be connected to the STB 106, the ad-monitor automation cloud-based service 204, and the engineering headend service 206 via a WAN (e.g., the Internet 114 of FIG. 1) so that the ad-monitor automation client 202 instantiated in the automation client computer 101 can communicate with the STB 106, the ad-monitor automation cloud-based service 204, and the engineering headend service 206. In some examples, the automation client computer 101 is instead connected to the STB 106 via a direct peripheral connection (e.g., a universal serial bus (USB) connection), via a short-range wireless peer-to-peer connection (e.g., a wireless Bluetooth connection), via a local area network (LAN) (e.g., an Ethernet connection), via a wireless local area network (WLAN) (e.g., a wireless Ethernet connection), or any other suitable type of connection. Although the automation client computer 101 is shown connected to one STB 106, in other example, the automation client computer 101 may be connected to any number of STBs. In such examples, the automation client computer 101 performs parallel implementation of examples disclosed herein (e.g., concurrent execution of ad-monitoring automation tasks) based on multiple concurrently connected STBs that are accessing media in parallel (e.g., from the headend system 104). In some examples, the number of STBs that the automation client computer 101 can be connected to is based on the available computing resources of the automation client computer 101.

Although the ad-monitor automation cloud-based service 204 is referred to as cloud-based, examples disclosed herein may be implemented using an ad-monitor automation remote service that is not cloud-based or that is connected to a cloud but does not perform its ad-monitoring processes in the cloud. For example, an ad-monitor automation remote service may be implemented in one or more servers that are not cloud based and that are connected to the automation client computer 101 via a WAN and/or via a cloud service that operates as network infrastructure between the ad-monitor automation remote service and the automation client computer 101.

The ad-monitor automation cloud-based service 204 is provided with an example graphical user interface (GUI) 208. The GUI 208 provides user input fields and user controls to allow a user to enter ad-monitoring configuration information for different ad-monitoring parameters. The ad-monitoring parameters are used to control the STB 106 to generate logged advertisement information (e.g., logged ad-monitoring information, ad impression logs). For example, the STB 106 monitors DAI advertisement activity at the STB 106 based on the ad-monitoring parameters, generates advertisement information about the DAI monitoring, and stores the advertisement information in an example ad information log store 210 as logged advertisement information. Example ad-monitoring parameters include television channel ID, monitoring start time, monitoring end time, log collection time intervals (e.g., intervals for the ad-monitor automation client 202 to send impression logs from the STB 106 to the ad-monitor automation cloud-based service 204), and/or any other suitable type of ad-monitoring parameters. The ad information log store 210 may be implemented using any suitable type of memory and/or storage device. In some examples, the ad-monitor automation cloud-based service 204 implements user-level access control, including authentication, authorization, and auditing, using the GUI 208 to prevent unauthorized access and increase brand safety of advertisers.

In examples disclosed herein, a television channel ID and a television network identifier refer to a call sign or channel name of a television broadcast station such as CNN, FOX, WFLD, ESPN, ABC, NBC, CBS, WGN (e.g., WGN-TV), etc. The television channel ID (or television network identifier) differs from a channel number in that the television broadcast station identified by a corresponding television channel ID may stream or be broadcast on different channel numbers in different markets. As such, a television channel ID (or television network identifier) may stream on one channel number (e.g., channel 5) in a first market and a different channel number (e.g., channel 7) in a second market.

The engineering headend service 206 provides content metadata that describes television channels and/or media streams that are accessible by the STB 106. For example, the STB 106 may be subscribed to a particular television service provider and/or a particular media service tier. The television service provider and/or the media service tier may define what television channels and/or media streams are accessible by the STB 106. The ad-monitor automation client 202 and the ad-monitor automation cloud-based service 204 may access a listing of the television channels/streams (e.g., Telemundo, Cable News Network (CNN), Fox News, British Broadcasting Corporation (BBC), Public Broadcasting Service (PBS), etc.) available to the STB 106 in the content metadata from the engineering headend service 206.

During an initialization phase, when the automation client computer 101 is connected to the STB 106, the ad-monitor automation client 202 obtains a network address of the STB 106 and registers itself and the STB 106 with the ad-monitor automation cloud-based service 204. For example, the ad-monitor automation client 202 can send a registration request to the ad-monitor automation cloud-based service 204 in a hypertext transfer protocol (HTTP) request. In some examples, the ad-monitor automation client 202 performs self-registration (e.g., autonomous self-registration) with the ad-monitor automation cloud-based service 204. In other examples, the ad-monitor automation client 202 receives user input via a GUI that initiates registration of the ad-monitor automation client 202 with the ad-monitor automation cloud-based service 204. After registration, the ad-monitor automation client 202 generates an automation client health status indicative of its health and obtains an STB health status of the STB 106. The automation client health status includes information indicative of whether the ad-monitor automation client 202 is functioning properly and ready to participate in DAI ad monitoring (e.g., T2-level ad monitoring). The STB health status includes information indicative of whether the STB 106 is functioning properly and ready to participate in ad monitoring. The ad-monitor automation client 202 reports the automation client health status and the STB health status to the ad-monitor automation cloud-based service 204 (e.g., via an HTTP request). In some examples, the ad-monitor automation client 202 collects STB health status updates from the STB 106 and generates its own automation client health status updates from time to time and sends the health status updates to the ad-monitor automation cloud-based service 204 at suitable polling intervals. The ad-monitor automation cloud-based service 204 uses the health status updates to confirm that the ad-monitor automation client 202 and the STB 106 are online and operational.

The ad-monitor automation cloud-based service 204 analyzes the health statuses to determine whether the ad-monitor automation client 202 and the STB 106 are healthy and active. If the ad-monitor automation cloud-based service 204 determines that the ad-monitor automation client 202 and the STB 106 are healthy and active, the ad-monitor automation cloud-based service 204 determines that DAI ad monitoring can begin. In some examples, the ad-monitor automation cloud-based service 204 generates and displays a notification via the GUI 208 to inform a user that the ad-monitor automation client 202 and the STB 106 are ready to begin ad monitoring. In other examples, the ad-monitor automation cloud-based service 204 sends one or more commands to the ad-monitor automation client 202 (e.g., via an HTTP response) that include(s) ad-monitoring parameters previously submitted by a user via the GUI 208 to specify what television channel/stream to monitor and/or other associated ad-monitoring configuration information described above.

To configure a DAI ad-monitoring session, the ad-monitor automation cloud-based service 204 displays the GUI 208. After a user interacts with the GUI 208 to enter the television channel/stream to be monitored, the ad-monitor automation cloud-based service 204 generates a remote-based (e.g., cloud-based, server-based, user-based) monitor-start command (e.g., an HTTP command) that includes a channel identifier (ID) indicative of the user-specified television channel/stream. The ad-monitor automation cloud-based service 204 sends the remote-based monitor-start command to the ad-monitor automation client 202 (e.g., via an HTTP response).

The ad-monitor automation client 202 receives the remote-based monitor-start command and cross-verifies whether the channel scheduled by (e.g., indicated in) the remote-based monitor-start command is accurate and available to the STB 106. For example, the ad-monitor automation client 202 sends a request or query that includes the channel ID to the engineering headend service 206. The engineering headend service 206 cross-references the channel ID with a listing of television channels/streams. As described above, the listing of the television channels/streams identifies which television channels/streams are available for access by the STB 106. If the channel ID is available in the listing of television channels/streams, the engineering headend service 206 generates a response that includes a channel number corresponding to the channel ID and returns the response to the ad-monitor automation client 202.

After receiving the channel number from the engineering headend service 206, the ad-monitor automation client 202 commands the STB 106 to stream the channel. For example, the ad-monitor automation client 202 obtains a corresponding channel number from the listing of television channels/streams from the engineering headend service 206 and sends an STB command that includes the channel number to the STB 106. In some examples, the ad-monitor automation client 202 includes the STB device ID of the STB 106 in the STB command. In other examples, the STB device ID may be omitted (e.g., the connection between the ad-monitor automation client 202 and the STB 106 is a point-to-point connection). After the STB 106 streams the channel number, the STB 106 sends the metadata (e.g., the channel ID) associated with the channel number back to the ad-monitor automation client 202. The ad-monitor automation client 202 compares the received the metadata (e.g., the channel ID) with the channel ID received from the remote-based monitor-start command in the ad-monitor automation cloud-based service 204 to determine whether the channel streamed by the STB 106 is actually the one intended by the user via the GUI 208. If the metadata (e.g., the channel ID) does not match the user-requested channel ID, the user-requested channel ID is not available at the STB 106, and the ad-monitor automation client 202 sends an error back to the ad-monitor automation cloud-based service 204 to be displayed in the GUI 208.

If verification of the channel ID fails, the ad-monitor automation client 202 determines not to perform the requested ad monitoring and sends a failure notification to that effect to the ad-monitor automation cloud-based service 204. Upon receipt of the failure notification, the ad-monitor automation cloud-based service 204 can display the notification via the GUI 208. However, if the channel ID verification is successful, the ad-monitor automation client 202 generates a STB monitor-start command based on the remote-based monitor-start command. For example, the ad-monitor automation client 202 converts the remote-based monitor-start command to a command that is readable and executable by the STB 106 to tune to the specified channel ID and perform DAI ad monitoring on that television channel/stream.

Upon receipt of the STB monitor-start command, the STB 106 tunes or selects the television channel/stream based on the channel ID in the STB monitor-start command and generates advertisement impression logs to log ad-monitoring information corresponding to DAI ads (T2-level ads) presented while streaming the television channel/stream. Example logged advertisement information (e.g., logged ad-monitoring information, ad impression logs) includes network and/or advertisement parameters from the GAR 162 (FIG. 1). For example, the network and/or advertisement parameters maybe based on a GAR specification and may include parameters such as ad ID, ad break ID (e.g., an ad break descriptor 126), channel ID (e.g., television network identifier) of a television channel/stream, mode (e.g., a live mode, a video-on-demand (VOD) mode, a digital video recording (DVR) mode, etc.), environment (e.g., production or staging), network ID (e.g., Internet service provider network ID), STB device ID, STB IP address, audience ID (e.g., a publisher-provided identifier (PPid)), unique device advertising ID (DVADID) (e.g., a device advertising ID corresponding to an STB and used for user-level addressability of advertisements), household ID (HHID) (e.g., used for household-level addressability of advertisements), opt-in privacy flag (fw_us_privacy) (e.g., present if user has opted in to ad monitoring, otherwise user has opted out), video taxonomy parameters (e.g., video genre, video rating, video series), custom site section ID (CSID), Custom content video asset ID (CAID), prebid validation (e.g., key value pairs indicating a successful bid request), and/or a site section tag. The STB 106 may obtain such example information in addition to any other suitable information from the DAI request 136 (FIG. 1) and/or the ad decision 172 (FIG. 1).

In examples disclosed herein, a site section tag (e.g., a custom site section ID (CSID)) refers to a string used to uniquely target and report ads within an ad server ecosystem. The site section tag may include a STB device ID (e.g., to identify which STB device is playing the ad), a network ID (e.g., identifying the network on which the ad is served/seen), and a mode used by an audience member to stream the channel (e.g., LIVE, VOD, DVR, etc.). An example site section tag string is “dtve_stb_genie_watch_live_espn.” In this example, “dtve_stb_genie” is a parameter value of a STB type parameter and represents a “Genie” model television media access client of DirecTV (e.g., a media service provider). The STB type parameter value is statically set to “dtve_stb_genie” for all users of “Genie” model television media access clients. Also in this example, “watch_live” is a parameter value of a viewing mode parameter and is indicative that an audience member is tuned to a live channel. The viewing mode parameter value is dynamic and is based on the television viewing mode selected by an audience member. In addition, “espn” is a parameter value of a network name parameter and is indicative that the audience member accessed the ESPN television channel/stream. The network name parameter value is dynamic and is based on which channel/stream the audience member accessed.

Collecting ad-monitoring information from the DAI request 136 (FIG. 1) and/or ad schedule information corresponding to break identifiers in the DAI schedule database 150 allows the ad-monitor automation client 202 to verify that a response in an ad decision 172 was received by the STB 106 and suitable for a corresponding DAI request 136 and associated GAR 162. The ad-monitor automation client 202 uses input from the ad-monitor automation cloud-based service 204 to monitor whether a break identifier (e.g., a break descriptor 126 of FIG. 1) sent in a DAI request 136 is enabled or disabled for dynamic ad selection (e.g., dynamic ad insertion) of a T2-level ad. For example, the ad-monitor automation client 202 can compare a first parameter value (e.g., a break identifier of an ad break 124) of a DAI request 136 logged in the logged advertisement information to a second parameter value (e.g., a break identifier of an ad break 124) in the ad schedule information in the DAI schedule database 150 by sending an HTTP request that includes a corresponding break identifier to the ad-monitor automation cloud-based service 204. In turn, the ad-monitor automation cloud-based service 204 sends a request to the DAI break enabler 102 to retrieve the status of the break identifier in the ad schedule information in the DAI schedule database 150. The response returned by the DAI break enabler 102 is then forwarded by the ad-monitor automation cloud-based service 204 to the ad-monitor automation client 202 to perform the verification.

If ad-monitoring information from an ad decision 172 is logged for a DAI request 136, and an associated GAR 162 is enabled (e.g., eligible for dynamic ad selection/insertion of a T2-level ad), the ad-monitor automation client 202 can determine that the ad decision 172 indicated DAI-eligibility for a corresponding ad break 124 which resulted in a successful ad response with T2-level ads. The ad-monitor automation client 202 sends information indicative of the DAI-eligibility and the successful T2-level ad selection through an HTTP request to the ad-monitor automation cloud-based service 204. In some examples, this information is displayed via the GUI 208 of the ad-monitor automation cloud-based service 204.

If ad-monitoring information from an ad decision 172 is logged for a DAI request 136, and an associated GAR 162 is disabled (e.g., not eligible for dynamic ad selection/insertion of a T2-level ad), the ad-monitor automation client 202 can determine that the ad decision 172 returned an ad response that indicated DAI-ineligibility for a corresponding ad break 124. The ad-monitor automation client 202 sends a corresponding error message indicating the DAI-ineligible ad response to the ad-monitor automation cloud-based service 204 via an HTTP request. The ad-monitor automation cloud-based service 204 can display this information via the GUI 208.

When the ad-monitor automation client 202 determines that parameter values do not match or that one or more parameter values is/are missing between a DAI request 136 and ad schedule information in the DAI schedule database 150, the ad-monitor automation client 202 determines that the received ad-monitoring information corresponding to the AD decision 172 does not match with the received ad-monitoring information corresponding to the DAI request 136 (and associated GAR 162). In such instances, the ad-monitor automation client 202 determines there is an incomplete record and sends an error report indicative of a potential error (e.g., an incomplete record) to the ad-monitor automation cloud-based service 204 via an HTTP request. The ad-monitor automation cloud-based service 204 can display this information via the GUI 208. The ad-monitor automation client 202 can determine that the ad decision 172 was suitable if it includes a T2 ad identifier 168 and includes a break descriptor 126 matching a break descriptor 126 in the DAI request 136.

Example logged advertisement information also includes impression confirmations representative of presentations of advertisements via the STB 106. In examples disclosed herein, impression confirmations are tracking events to track the progress of an advertisement presentation via a STB. Impression confirmations may be used as currency of digital advertisements because when they evidence presentations of corresponding advertisements, such evidence is the basis for a television network (e.g., a broadcaster) to be paid by an advertiser for the presentation of a corresponding ad break 124. In some examples, a single impression confirmation is logged for an ad presentation. In other examples, multiple progress-impression confirmations are logged during an ad presentation to track its progress. Such multiple progress-impression confirmations can be used to confirm whether the entirety of an ad was presented (e.g., a user remained tuned to the same television channel for the duration of the ad) or to determine whether less than the entire ad was presented (e.g., a user tuned the STB 106 away from the television channel during the ad presentation).

Example progress-impression confirmations can be logged at periodic intervals. The duration of the periodic intervals can be based on the length of the ad spot. For example, 7.5-second intervals may be used for a 30-second advertisement, and 15-second intervals may be used for a 60-second advertisement. For a 30-second advertisement of an ad break 124, the STB 106 may log a “slot start impression” confirmation at the 0-second mark of the ad break 124, log a “default impression” confirmation at the 1-second mark of an ad presented in the ad break 124, log a “first quartile impression” confirmation at the 7.5-second mark of the ad, log a “midpoint impression” confirmation at the 15-second mark of the ad, log a “third quartile impression” confirmation at the 22.5-second mark of the ad, and log a “complete impression” confirmation at the 30s mark of the ad. For a second or any subsequent ad presented during the same ad break 124, the STB 106 logs multiple progress-impression confirmations in similar manner. At the end of the ad break 124, the STB 106 logs a slot end impression confirmation. The logging of the “default impression”, the “first quartile impression”, the “midpoint impression”, the “third quartile impression”, and the “complete impression” for an ad indicates that the entirety of the ad was presented at the STB 106.

The “slot start impression” and the “slot end impression” demarcate the beginning and end of the ad break 124 during which multiple ads can be presented. At the “slot start impression”, the STB 106 has not yet been served an ad. The “default impression” refers to a single instance of an ad displayed within a designated ad slot of the ad break 124. The “default impression” indicates that the ad has been served and is visible to a user. The “first quartile impression” indicates that an ad was presented for 25% of the total ad duration. The “midpoint impression” indicates that the ad was presented for 50% of the total ad duration. The “third quartile impression” indicates that the ad was presented for 75% of the total ad duration. The “complete impression” indicates that the ad was presented for 100% of the total ad duration.

In some examples, the STB 106 may also log impression confirmations for different television control events such as pause, resume, audio mute, audio unmute, rewind, fast-forward, etc. For example, if a user pauses an ad, the STB 106 logs a pause impression confirmation. When the user un-pauses the ad, the STB 106 logs a resume impression confirmation. If the user turns off the audio during an ad, the STB 106 logs a mute impression confirmation and when the user turns the audio back on, the STB 106 logs an unmute impression.

In some examples, the STB 106 may also fire or transmit notifications (e.g., beacons) to third-party servers for third-party impression tracking. For example, an ad creative may cause third-party data gathering associated with its playback by the STB 106. An example of third-party impression tracking includes the use of a 1×1 tracking pixel located in the ad that causes a STB to transmit redirect pings to various data collection services, resellers, etc. that log impressions based on the received pings and perform analytical processes based on the logged impressions.

The ad-monitor automation client 202 collects the logged advertisement information from the STB 106 at periodic or aperiodic intervals. For example, the ad-monitor automation client 202 may collect the logged advertisement information from the STB 106 every 15 seconds or at any other suitable interval. For example, the ad-monitor automation client 202 may poll the STB 106 every 15 seconds for the logged advertisement information. The ad-monitor automation client 202 parses the logged advertisement information, verifies the logged advertisement information against predefined advertisement key performance indicators (KPIs), and converts the logged advertisement information from an STB format to a user-readable format. The ad-monitor automation client 202 performs such verification process to confirm that expected network and/or advertisement parameters are present in the logged advertisement information. For example, confirmation that an advertisement was presented by the STB 106 may rely on the presence of particular network and/or advertisement parameters in the logged advertisement information. The ad-monitor automation client 202 performs such verification process to confirm that an ad decision 172 was received by the STB 106 and was suitable for a corresponding DAI request 136 and associated GAR 162. For example, the ad-monitor automation client 202 can determine that the ad decision 172 was suitable if it identified an ad (e.g., the T2 ad identifier 168) to be presented and the correct break descriptor 126 of an upcoming ad break 124. The presence and/or accuracy of other parameters may also be used by the ad-monitor automation client 202 to determine suitableness of the ad decision 172.

The ad-monitor automation client 202 may interpret the absence of any of such network and/or advertisement parameters from a logged ad-monitoring record as a non-presentation or non-impression of an advertisement corresponding to that record. If a record in the logged advertisement information is incomplete, the ad-monitor automation client 202 forwards the record, and a notification indicating a potential error or issue in the record, to the ad-monitor automation cloud-based service 204. However, the presence of expected network and/or advertisement parameters in the logged ad-monitoring record is interpreted by the ad-monitor automation client 202 as a complete record that can be forwarded to the ad-monitor automation cloud-based service 204 for subsequent ad-monitoring analysis.

The ad-monitor automation client 202 also parses through the logged advertisement information to determine fill rate. As used herein, fill rate means the sum total ad duration of all the ads shown during an ad break 124 divided by the ad break duration of the ad break 124. For example, if the ad break duration of an ad break 124 is 60 seconds and a first ad of 30 seconds was presented, a second ad of 15 seconds was presented, and a third ad of 6 seconds was presented for a sum total ad duration of 51 seconds (e.g., 30 seconds+15 seconds+6 seconds), the fill rate for that ad break 124 is 85% (e.g., 51/60). In some examples, the ad-monitor automation client 202 includes the fill rate in the logged advertisement information so that the fill rate is sent to the ad-monitor automation cloud-based service 204.

The ad-monitor automation client 202 also parses through the logged advertisement information to identify incorrectly logged impressions. An impression confirmation should be logged by the STB 106 only for ads that are presented. In addition, progress-impression confirmations (e.g., “default impression”, “first quartile impression”, “midpoint impression”, “third quartile impression”, and “complete impression”) should be logged by the STB 106 in chronological order. The ad-monitor automation client 202 analyzes the logged advertisement information to determine irregularities in logging of impression confirmations and uses any such detected irregularities to determine that an ad cannot be credited as presented. In some examples, the ad-monitor automation client 202 determines that the logged advertisement information does not indicate presentation of a second ad via the STB 106 after the STB 106 tuned away from a monitored television channel/stream during presentation of a first ad. For example, if a user viewing a television channel/stream via the STB 106 tunes away from the television channel/stream during presentation of a first ad in an ad break 124 or after the presentation of the first ad is completed but before presentation of a second ad in the same ad break 124, the STB 106 should not log any impression confirmations corresponding to the second ad because the second ad was not presented. However, if the ad-monitor automation client 202 detects one or more impression confirmations for the second ad in the logged advertisement information, the ad-monitor automation client 202 determines that the record in the logged advertisement information corresponding to the second ad is in error and, therefore, non-verifiable.

In some examples, the ad-monitor automation client 202 detects a tune-away event during which the STB 106 tunes away from a first television channel/stream to a second television channel/stream by continuously reading metadata from the STB 106 to identify the television channel/stream that is actively streaming. The ad-monitor automation client 202 detects channel changes in substantially real-time by monitoring channel metadata changes during ad monitoring and sends out a notification to the ad-monitor automation cloud-based-service 204 to indicate the STB 106 has tuned away. Such a tune-away event is displayed by the ad-monitor automation cloud-based-service 204 in the GUI 208. In other examples, the ad-monitor automation client 202 detects a tune-away event by analyzing the logged advertisement information generated by the STB 106 to indicate impressions logged for all of a first ad in an ad break 124 and no impressions for a second ad (e.g., provided the ad break 124 has two sets of ads in an ad response returned in an ad decision 172).

Based on the verification process, the ad-monitor automation client 202 keeps successfully verified records in the logged advertisement information. In examples disclosed herein, the ad-monitor automation client 202 also keeps records that are unverifiable due to potential errors in the logged advertisement information and generates a report indicating the potential errors or issues in the unverifiable records. The ad-monitor automation client 202 generates an HTTP response and adds the logged advertisement information into a payload field of the HTTP response. The ad-monitor automation client 202 then sends the logged advertisement information in the HTTP response to the ad-monitor automation cloud-based services 204. In some examples, the ad-monitor automation client 202 sends the logged advertisement information to the ad-monitor automation cloud-based service 204 in multiple payload fields of multiple HTTP responses.

The ad-monitor automation cloud-based service 204 stores the logged advertisement information so that the logged advertisement information is subsequently retrievable and displayable in the GUI 208. In some examples, the ad-monitor automation cloud-based service 204 cross-verifies whether ad breaks 124 (e.g., of the media stream 118) identified in the logged advertisement information were correctly enabled for DAI ad insertion. For example, the ad-monitor automation cloud-based service 204 can access break identifiers of a television channel/stream for particular times in the ad schedule information stored in the DAI schedule database 150 and compare break identifiers for the same times and television channel/stream in the logged advertisement information to the break identifiers form the ad schedule information. Based on such cross-verification, the ad-monitor automation cloud-based service 204 determines whether a DAI ad insertion was made for the correct audience member and at the correct ad break 124. If the ad-monitor automation cloud-based service 204 determines that the logged advertisement information includes any irregularities (e.g., a DAI ad insertion was not correctly made), the ad-monitor automation cloud-based service 204 can generate a corresponding alert/notification.

In the example of FIG. 2, the ad-monitor automation cloud-based service 204 is in communication with an example engineering service 212. The engineering service 212 may be implemented using a Sumo Logic® cloud computing service and is the storage place of ad server requests (e.g., Freewheel ad requests) which are generated by the ad routing service 144 based on corresponding GARs 162. In some examples, the ad-monitor automation cloud-based service 204 accesses ad server request information of ad server requests processed by the ad request server 142 and/or the ad routing service 144 to retrieve and monitor parameters in ad requests. For example, the ad-monitor automation cloud-based service 204 cross-verifies ad breaks 124 (e.g., of the media stream 118) identified in the logged advertisement information with information from corresponding GARs 162 sent to the ad routing service 144. As described above, the ad routing service 144 initiates/sends ad server requests (e.g., a FreeWheel ad requests) based on corresponding GARs 162 to the vendor APIs 156. In the example of FIG. 2, the ad-monitor automation cloud-based service 204 can access ad server request information from such an ad server request for a particular GAR 162 by generating an HTTP query request that includes a transaction identifier (e.g., extxid—c9f8a527-188f-4826-8aae-358cdfcbccc8) and a STB device identifier (e.g., dvadid—db17d4ce-7a72-4278-9158-cebb4f751fc3) present in the GAR 162, sending the HTTP request query to the engineering service 212, and retrieving the corresponding response (e.g., the requested ad server request information). The engineering service 212 maintains logs that include ad server request information of ad server requests processed by the ad request server 142 and/or the ad routing service 144. Example parameters that may be included in the ad server request include advertisement network identifier (e.g., CSID), advertisement video identifier (e.g., Custom content video asset ID (CAID)), IP address (e.g., STB IP address), advertisement content identifier (e.g., genre, TV rating, series) , header bidding key value parameters (e.g., hb_pb_cat_dur), Flag (e.g., indicative of capabilities supported by the ad server such as, for example, fbad-supports fallback ads), etc. The ad-monitor automation service 204 may obtain such example information in addition to any other suitable information from the ad server request. The ad-monitor automation cloud-based service 204 verifies that the logged advertisement information does not include any irregularities related to ad server request parameters (e.g., an invalid advertisement network identifier (CSID)). In addition, the ad-monitor automation cloud-based service 204 can generate a corresponding alert/notification if it detects an irregularity in the logged advertisement information.

In some examples, the ad-monitor automation cloud-based service 204 includes an example ad insights manager 214 that is capable of storing and retrieving data to provide ad insights such as ad load (e.g., ads served per minute). In some such examples, a 60 second ad break duration can present ads in any suitable ad sequence such as, for example: example sequence (ad1=30 s, ad2=30 s), example sequence (ad1=15 s, ad2=30 s, ad3=15 s), example sequence (ad1=15 s, ad2=15 s, ad3=15 s, ad4=15 s), example sequence (ad1=15 s, ad1=45 s), example sequence (ad1=60 s), etc. which result in an average of 2.4 ads per minute. The ad insights manager 214 can also show the type of ad received based on the creative URL (e.g., a creative from Publica (supply-side platform (SSP)), a Google ad server (Google Ad Manager (GAM) tag), etc.) captured in the shared report (e.g., the logged advertisement information) from the ad-monitor automation client 202. In some examples, the ad insights manager 214 can show trends on alerts that the ad-monitor automation cloud-based service 204 is sending per STB client over a time period (e.g., a week, a month, etc.) and decipher any alerts that are increasing or decreasing over comparable time periods (e.g., Month-on-Month (MoM), Week-on-Week (Wow), Year-on-Year(YoY), etc.).

The ad-monitor automation cloud-based service 204 sends predefined alerts/notifications to a mailing group of people involved with monitoring DAI ad insertion. In some examples, different mailing groups may be created for different television channels/streams. Example notifications that can be sent by the ad-monitor automation cloud-based service 204 include notifications of nonstandard ads, repeated ads, insufficient ads, network issues, error impressions, loud ads, ad request parameter failures, impression failures, and/or any other suitable notifications. A nonstandard ad notification refers to an ad having a duration other than predefined or standard durations for an ad break 124. In some examples, predefined or standard durations of ads are multiples of 15 seconds (e.g., 15 seconds(s), 30 s, 45 s, 60 s, 75 s, and 90 s). Example durations of non-standard ads include 6 s, 8 s, 9 s, 10 s, 21 s, or any other duration that is not a predefined duration established by, for example, a media delivery provider that operates the headend system 104. A repeated ad notification refers to an ad that has been repeated more than a threshold frequency within a particular duration or that was repeated in the same ad break 124. An insufficient ads notification represents a fill rate that is less than a duration of a corresponding ad break 124 (e.g., less than 100% of the ad break 124). A network issue notification is indicative of an ad having been affected by a possible network failure or other network problem. In some examples, a network issue corresponds to a timeout because the STB 106 did not receive a response within a threshold duration from the impression host identified in an ad response (e.g., the ad decision 172 of FIG. 1 inclusive of creative URL's, Freewheel impressions, and third-party impressions). A network issue notification and/or an error impression notification is/are indicative of an ad impression having been affected by a possible certificate issue or a failure to connect to the impression host identified in an ad response. A loud ads notification corresponds to an ad that does not have an audio volume that substantially matches corresponding content 122 (e.g., in the media stream 118 of FIG. 1). For example, the ad-monitor automation cloud-based service 204 may generate a loud ad notification in response to an ad having an audio volume that exceeds a loudness threshold greater than corresponding content 122. In some examples, such loudness threshold is −24 to −26 LKFS (Loudness, K-weighted, relative to full scale) such that an audio volume greater than −26 LKFS triggers a loud ad notification.

An ad request parameter failure notification is indicative that an ad request parameter is missing or invalid in the logged advertisement information (e.g., the DAI request 136 is missing the STB device identifier or the DAI request 136 has an invalid ‘channel ID’ or ‘mode’). An impression failure notification is used to indicate that logged advertisement information includes a logged ad request (e.g., the DAI request 136) and a logged ad response (e.g., the ad decision 172) when there was a successful GAR 162 and a corresponding DAI ad was presented but that the logged advertisement information is missing a corresponding logged impression confirmation (e.g., no impression was recorded or that insufficient impression confirmations were recorded for the logged ad request and ad response). This is useful information because a television network (e.g., a broadcaster) relies on logged impressions as evidence that an advertiser's ad was presented so that the television network can request payment for that presented ad from the advertiser. In some examples, a television network (e.g., a broadcaster) gets paid by an advertiser based on logging of a “default impression” described above. In other examples, a television network (e.g., a broadcaster) gets paid by an advertiser only if all progress-impressions (e.g., the “default impression”, the “first quartile impression”, the “midpoint impression”, the “third quartile impression”, and the “complete impression”) for an ad are logged. In such examples, an ad request parameter and impression failure notification is indicative that less than all progress-impressions (e.g., the “default impression”, the “first quartile impression”, the “midpoint impression”, the “third quartile impression”, and the “complete impression”) for an ad were logged.

Based on the alerts/notifications, the DAS system 110 may be re-configured or adjusted to correct how the media distribution system 100 performs ad-selections and/or ad-presentations. In some examples, schedule information corresponding to break identifiers may be updated in the DAI schedule database 150 to correctly identify ad breaks 124 and schedule information to enable those ad breaks 124. Additionally or alternatively, DAI enablement rules in the DAI enablement rules database 140 may be updated to re-define which of the ad breaks 124 in the media stream 118 are to be enabled for dynamic ad selection (e.g., dynamic ad insertion). Additionally or alternatively, audience profile information may be adjusted in the profile database 152 to more accurately represent audience members.

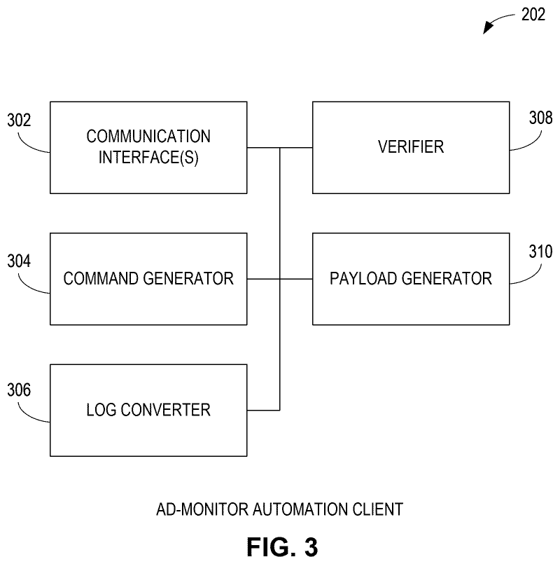

FIG. 3 is a block diagram of an example implementation of the ad-monitor automation client 202 of FIG. 2 to monitor presentations of ads placed using DAI. The ad-monitor automation client 202 of FIG. 3 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the ad-monitor automation client 202 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The ad-monitor automation client 202 includes one or more example communication interface(s) 302, an example command generator 304, an example log converter 306, an example verifier 308, and an example payload generator 310. The communication interface(s) 302 is provided to communicate with the STB 106 and the ad-monitor automation cloud-based service 204. For example, a single communication interface 302 may be provided if the ad-monitor automation client 202 communicates with the STB 106 and the ad-monitor automation cloud-based service 204 via the same WAN (e.g., the Internet 114 of FIG. 1). Alternatively, two communication interfaces 302 may be provided if the ad-monitor automation client 202 communicates with the STB 106 via a first network (e.g., a LAN, a WLAN, etc.) or a direct connection (e.g., USB, Bluetooth, etc.) and communicates with the ad-monitor automation cloud-based service 204 via a second network (e.g., the Internet 114).

The command generator 304 is provided to generate STB commands based on remote-based commands (e.g., cloud-based commands, server-based commands, user-based commands) from the ad-monitor automation cloud-based service 204. For example, the command generator 304 converts the server-based commands into commands that are readable and executable by different types of STB's. Examples of different types of STB's include STB's provided by different media delivery providers such as DirecTV® STB, an AT&T® STB, etc. The command generator 304 causes the communication interface 302 to send the STB commands to the STB 106.

The log converter 306 is provided to convert logged advertisement information from the STB 106 into a human-readable format. By converting the logged advertisement information to a human-readable format, the ad-monitor automation cloud-based service 204 can display the logged advertisement information via the GUI 208 for review by a user. In other examples, the log conversion can be performed at a different location such as in the ad-monitor automation cloud-based service 204 or in the STB 106.

The verifier 308 is provided to perform verification operations on the logged advertisement information as described above. The payload generator 310 is provided to generate payloads that include the logged advertisement information to be sent to the ad-monitor automation cloud-based service 204 (e.g., via an HTTP request).

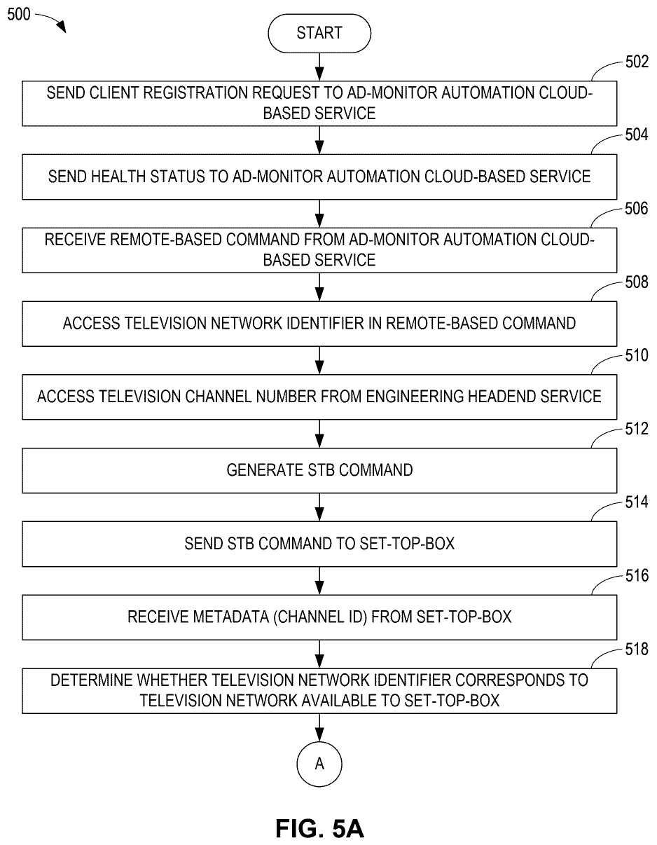

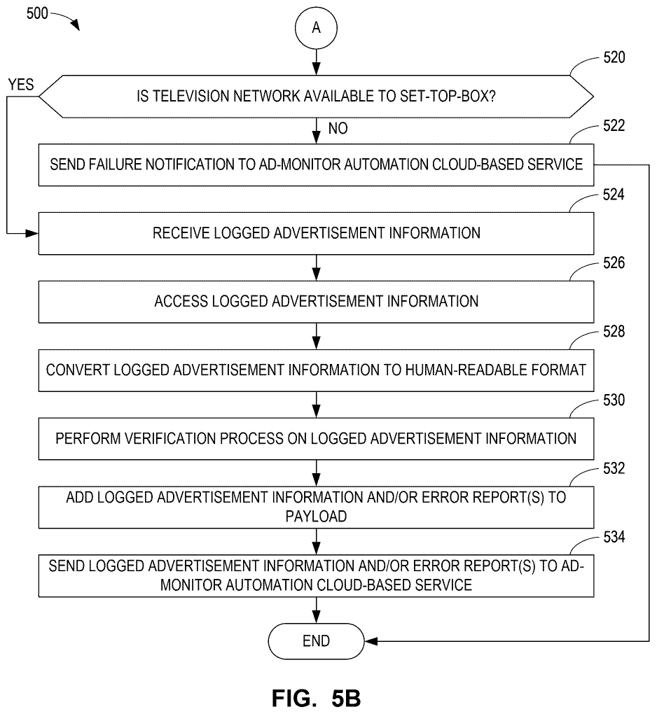

In some examples, the communication interface(s) 302, the command generator 304, the log converter 306, the verifier 308, and the payload generator 310 are circuitry (e.g., the communication interface circuitry, the command generator circuitry, the log converter circuitry, the verifier circuitry, and the payload generator circuitry) instantiated by programmable circuitry executing instructions and/or configured to perform operations such as those represented by the flowchart of FIGS. 5A and 5B.

As described above, the communication interface(s) 302, the command generator 304, the log converter 306, the verifier 308, and the payload generator 310 of FIG. 3 are structures. Such structures may implement means for performing corresponding disclosed functions. Examples of such functions are described above in connection with corresponding ones of the communication interface(s) 302, the command generator 304, the log converter 306, the verifier 308, and the payload generator 310 and are described below in connection with the flowchart of FIGS. 5A and 5B.

While an example manner of implementing the ad-monitor automation client 202 of FIG. 2 is illustrated in FIG. 3, one or more of the elements, processes, and/or devices illustrated in FIG. 3 may be combined, divided, re-arranged, omitted, eliminated, and/or implemented in any other way. Further, the communication interface(s) 302, the command generator 304, the log converter 306, the verifier 308, and the payload generator 310, and/or, more generally, the example ad-monitor automation client 202 of FIG. 3, may be implemented by hardware alone or by hardware in combination with software and/or firmware. Thus, for example, any of the communication interface(s) 302, the command generator 304, the log converter 306, the verifier 308, and the payload generator 310, and/or, more generally, the example ad-monitor automation client 202, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs in combination with machine-readable instructions (e.g., firmware or software). Further still, the example ad-monitor automation client 202 of FIG. 3 may include one or more elements, processes, and/or devices in addition to, or instead of, those illustrated in FIG. 3, and/or may include more than one of any or all of the illustrated elements, processes and devices.

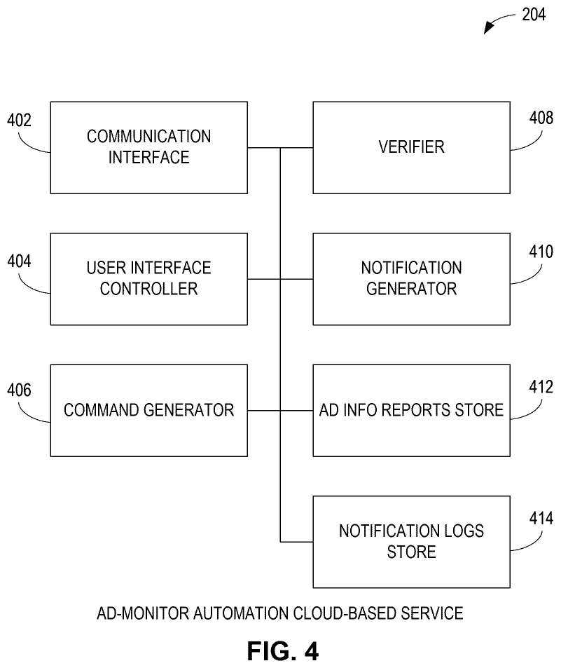

FIG. 4 is a block diagram of an example implementation of the ad-monitor automation cloud-based service 204 of FIG. 2 to obtain ad-monitoring parameters from users and send remote-based commands to the ad-monitor automation client 202. The ad-monitor automation cloud-based service 204 of FIG. 4 may be instantiated (e.g., creating an instance of, bring into being, materialize, implement, etc.) by programmable circuitry such as a Central Processor Unit (CPU) executing instructions. Additionally or alternatively, the ad-monitor automation cloud-based service 204 of FIG. 4 may be instantiated (e.g., creating an instance of, bring into being, materialize, implement, etc.) by (i) an Application Specific Integrated Circuit (ASIC) and/or (ii) a Field Programmable Gate Array (FPGA) structured and/or configured to perform operations of the ad-monitor automation cloud-based service 204. It should be understood that some or all of the circuitry of FIG. 4 may be instantiated at the same or different times. Moreover, in some examples, some or all of the circuitry of FIG. 4 may be implemented by microprocessor circuitry executing instructions and/or FPGA circuitry performing operations to implement one or more virtual machines and/or containers.

The ad-monitor automation cloud-based service 204 includes an example communication interface 402, an example user interface controller 404, an example command generator 406, an example verifier 408, an example notification generator 410, an example ad information reports store 412, and an example notification logs store 414. The communication interface 402 is provided to communicate with the ad-monitor automation client 202 via a WAN (e.g., the Internet 114 of FIG. 1). The user interface controller 404 is provided to generate and/or display the GUI 208. In addition, the user interface controller 404 receives user input provided by a user via the GUI 208. The command generator 406 is provided to generate remote-based commands that include ad-monitoring configuration information based on ad-monitoring parameters provided by users via the GUI 208. The command generator 406 causes the communication interface 402 to send the remote-based commands to the ad-monitor automation client 202 (e.g., via HTTP responses).

The verifier 408 is provided to perform verification operations on the logged advertisement information received from the ad-monitor automation client 202 as described above. The notification generator 410 is provided to generate alerts/notifications to be sent to people involved with monitoring DAI ad insertion. Example notifications that can be generated by the notification generator 410 include notifications of nonstandard ads, repeated ads, insufficient ads, network issues, ad request parameter and/or impression failures.

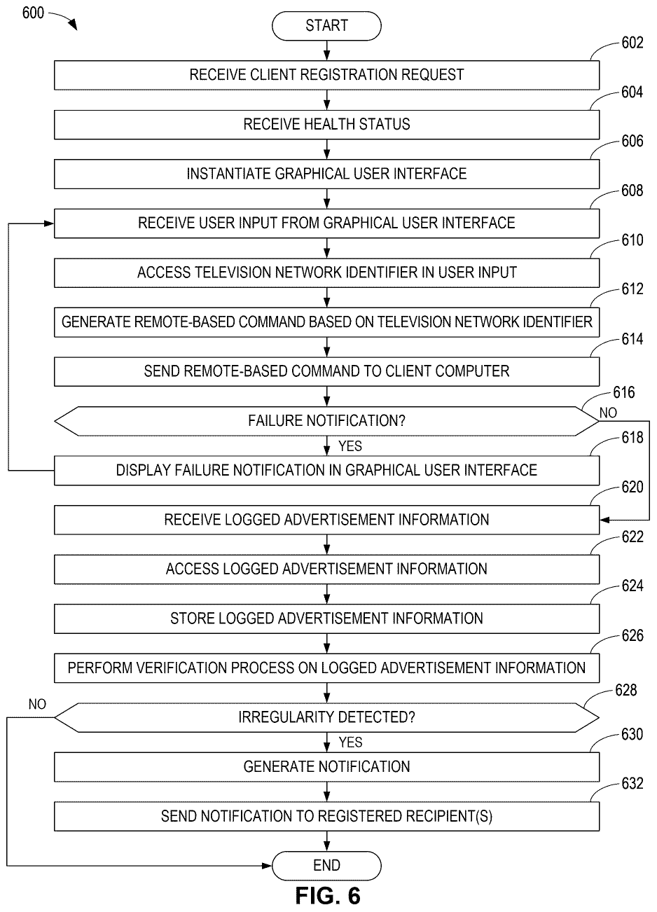

In some examples, the communication interface 402, the user interface controller 404, the command generator 406, the verifier 408, and the notification generator 410 are circuitry (e.g., communication interface circuitry, user interface controller circuitry, command generator circuitry, verifier circuitry, and notification generator circuitry) instantiated by programmable circuitry executing instructions and/or configured to perform operations such as those represented by the flowchart of FIG. 6.

The ad information reports store 412 is provided to store ad information reports. For example, the ad information report store 412 may store ad information reports that include the logged advertisement information received from the ad-monitor automation client 202. The notification logs store 414 is provided to store a history of notifications received from the ad-monitor automation client 202 for subsequent analytics/insights.

As described above, the communication interface 402, the user interface controller 404, the command generator 406, the verifier 408, the notification generator 410, the ad information reports store 412, the notification logs store 414 of FIG. 4, and the ad insights manager 214 of FIG. 2 are structures. Such structures may implement means for performing corresponding disclosed functions. Examples of such functions are described above in connection with corresponding ones of the communication interface 402, the user interface controller 404, the command generator 406, the verifier 408, and the notification generator 410 and are described below in connection with the flowchart of FIG. 6.

While an example manner of implementing the ad-monitor automation cloud-based service 204 of FIG. 2 is illustrated in FIG. 4, one or more of the elements, processes, and/or devices illustrated in FIG. 4 may be combined, divided, re-arranged, omitted, eliminated, and/or implemented in any other way. Further, the communication interface 402, the user interface controller 404, the command generator 406, the verifier 408, the notification generator 410, the ad information reports store 412, the notification logs store 414, and the ad insights manager 214, and/or, more generally, the example the ad-monitor automation cloud-based service 204 of FIG. 4, may be implemented by hardware alone or by hardware in combination with software and/or firmware. Thus, for example, any of the communication interface 402, the user interface controller 404, the command generator 406, the verifier 408, and the notification generator 410, the ad information reports store 412, the notification logs store 414, and the ad insights manager 214, and/or, more generally, the example ad-monitor automation cloud-based service 204, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs in combination with machine-readable instructions (e.g., firmware or software). Further still, the example ad-monitor automation cloud-based service 204 of FIG. 4 may include one or more elements, processes, and/or devices in addition to, or instead of, those illustrated in FIG. 4, and/or may include more than one of any or all of the illustrated elements, processes and devices.

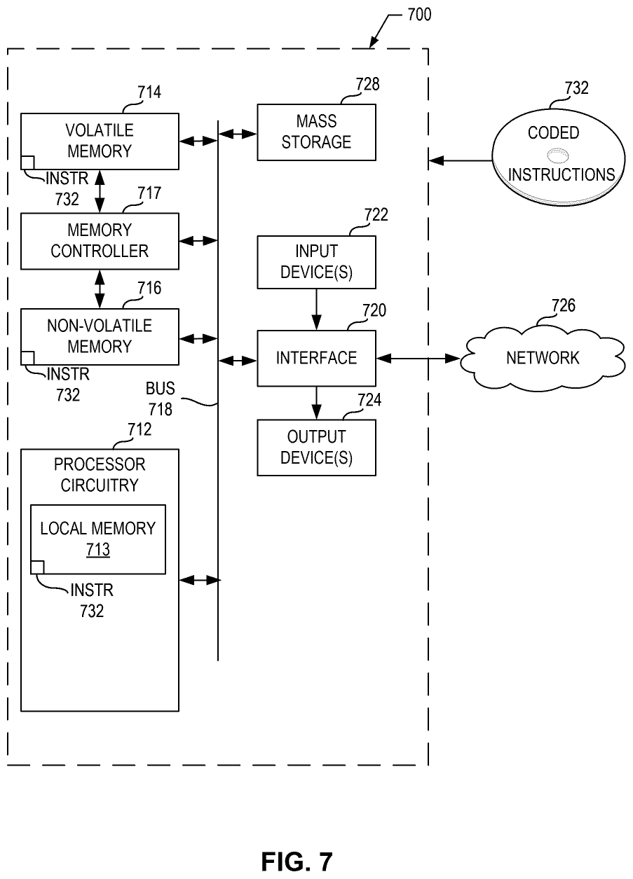

A flowchart of FIGS. 5A and 5B is representative of example machine-readable instructions that may be executed by programmable circuitry to implement and/or instantiate the ad-monitor automation client 202 of FIG. 3 and/or representative of example operations which may be performed by programmable circuitry to implement and/or instantiate the ad-monitor automation client 202. A flowchart of FIG. 6 is representative of example machine-readable instructions that may be executed by programmable circuitry to implement and/or instantiate the ad-monitor automation cloud-based service 204 of FIG. 4 and/or representative of example operations which may be performed by programmable circuitry to implement and/or instantiate the ad-monitor automation cloud-based service 204. The machine-readable instructions may be one or more executable program(s) or portion(s) of one or more executable program(s) for execution by programmable circuitry such as the programmable circuitry 712 shown in the example processor platform 700 discussed below in connection with FIG. 7 and/or may be one or more function(s) or portion(s) of functions to be performed by example programmable circuitry. In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine-readable storage media such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, read-only memory (ROM), a solid-state drive (SSD), non-volatile memory (e.g., electrically erasable programmable ROM (EEPROM), flash memory, etc.), volatile memory (e.g., Random Access Memory (RAM) of any type, etc.), and/or any other storage device or storage disk. The non-transitory computer readable storage medium may include one or more mediums and/or types of mediums. The instructions of the non-transitory computer readable and/or machine-readable medium may be executed and/or instantiated by one or more hardware devices other than the programmable circuitry and/or may be embodied in dedicated hardware. For example, any or all of the blocks of the flowchart(s) may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform corresponding operations without executing software or firmware.

Although the example program(s) is/are described with reference to the flowcharts illustrated in FIGS. 5A, 5B, and 6, other methods of implementing the example the ad-monitor automation client 202 and/or the ad-monitor automation cloud-based service 204 may alternatively be used. For example, the order of execution of the blocks of the flowcharts may be changed, and/or some of the blocks described may be changed, eliminated, or combined.

The machine-readable instructions may be distributed across multiple hardware devices and/or executed by two or more hardware devices (e.g., a server and a client hardware device). The programmable circuitry may be distributed in different network locations and/or may be local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

Machine-readable instructions as described herein may be stored as data and/or in a data structure (e.g., as portion(s) of instructions, code, representations of code, etc.) on one or more storage devices, disks and/or computing devices (e.g., servers) located at the same or different locations of a network or collection of networks (e.g., in the cloud, in edge devices, etc.).

The machine-readable instructions described herein can be written or represented using any suitable previously developed or future-developed instruction language, scripting language, programming language, query language, or database language, including, for example, C, C++, Java, C-Sharp, Perl, Python, JavaScript, TypeScript, HyperText Markup Language (HTML), Swift, Go (Golang), Rust, Bash, PowerShell, Ruby, Kotlin, Scala, PHP (Hypertext Preprocessor), Objective-C, R, Lua, Julia, MATLAB, Solidity, and any other language suitable for implementing the described functionality. This also includes database query languages, both structured and non-structured, such as Structured Query Language (SQL) and its extensions (Procedural Language/SQL (PL/SQL), Transact-SQL (T-SQL)), as well as non-structured database query languages, including MongoDB Query Language (MQL), Cassandra Query Language (CQL), Cypher (Neo4j), Gremlin, Redis command line interface (CLI) commands, DynamoDB API queries, MapReduce-based query frameworks, GraphQL, SPARQL, XQuery, JavaScript Object Notation Path (JSONPath), JSONiq, and Datalog, among any other present or future-developed query languages applicable to structured, semi-structured, and/or unstructured databases. Additionally, this may include languages and technologies used in artificial intelligence (AI), machine learning (ML), blockchain, and big data processing, such as TensorFlow scripts, PyTorch scripts, Apache Spark SQL, HiveQL, Solidity, Rust, Move, and other future-developed or domain-specific languages relevant to data processing, smart contracts, and/or computational modeling.

As mentioned above, the example operations of FIGS. 5A, 5B, and 6 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc. As used herein, the term “storage disk” refers to a physical structure containing information storage elements to which information can be written and persisted for subsequent retrieval by a computer or other hardware platform. Examples of non-transitory computer-readable medium, non-transitory computer-readable storage medium, non-transitory machine-readable medium, non-transitory machine-readable storage medium, non-transitory computer-readable storage devices, non-transitory machine-readable storage devices, non-transitory computer-readable storage disk, and/or non-transitory machine-readable storage disk include any one of or combination of random access memory (RAM) of any type, read only memory (ROM) of any type, solid state memory, flash memory, optical discs (e.g., a CD, a DVD, etc.), magnetic disks (e.g., magnetic HDDs), disk drives, cache, registers, redundant array of independent disks (RAID) systems, and/or any other non-transitory computer-readable and/or machine-readable media in which information is stored for any duration (e.g., for extended time periods, permanently, for brief instances, for temporarily buffering, and/or for caching of the information).

FIGS. 5A and 5B show a flowchart representative of example machine-readable instructions and/or example operations that may be executed, instantiated, and/or performed by example programmable circuitry to implement the ad-monitor automation client 202 of FIG. 3 to monitor presentations of ads placed using DAI. The example machine-readable instructions and/or the example operations 500 of FIGS. 5A and 5B begin at block 502, at which the communication interface 302 sends a client registration request to the ad-monitor automation cloud-based service 204. For example, the client registration request includes a request to register the ad-monitor automation client 202 and the STB 106 with the ad-monitor automation cloud-based service 204. At block 504, the communication interface 302 sends health status information to the ad-monitor automation cloud-based service 204. For example, the communication interface 302 sends an STB health status of the STB 106 and/or an automation client health status of the ad-monitor automation client 202 to the ad-monitor automation cloud-based service 204.

At block 506, the communication interface 302 receives a remote-based command from the ad-monitor automation cloud-based service 204. At block 508, the command generator 304 accesses a television network identifier in the remote-based command. For example, the television network identifier corresponds to a television channel/stream specified by the user for ad monitoring in the GUI 208. At block 510, the verifier 308 accesses a television channel number from the engineering headend service 206. For example, the verifier 308 can communicate with the engineering headend service 206 to obtain a channel number corresponding to the television network identifier in the remote-based command. At block 512, the command generator 304 generates an STB command to perform DAI ad monitoring. For example, the command generator 304 includes the channel number received from the engineering headend service 206 in the STB command. In some examples, the command generator 304 can also include other monitoring parameters from the remote-based command in the STB command. At block 514, the communication interface 302 sends the STB command to the STB 106. At block 516, the communication interface 302 receives metadata (e.g., a television network identifier) from the STB 106. For example, the STB 106 tunes to a television network corresponding to the channel number identified in the STB command, receives the corresponding media stream (e.g., the media stream 118 of FIG. 1), obtains the metadata from the media stream, and sends the metadata to the communication interface 302 of the ad-monitor automation client 202.

At block 518, the verifier 308 determines whether the television network identifier received in the remote-based command from the ad-monitor automation cloud-based service 204 at block 506 corresponds to a television network (e.g., television channel/stream) available to (e.g., streamable by) the STB 106. For example, the verifier 308 can compare the television network identifier received in the remote-based command to the television network identifier received in (e.g., identified in) the metadata from the STB 106 at block 516. If the two television network identifiers match, the verifier 308 confirms that the television network identifier received in the remote-based command corresponds to a television network available to the STB 106. Otherwise, if the two television network identifiers do not match, the verifier 308 determines that the television network identifier received in the remote-based command does not correspond to a television network available to the STB 106. In some examples, the television network identifiers do not match because the channel number tuned to by the STB 106 corresponds to a television network having a television network identifier different from the television network identifier in the remote-based command. If the verifier 308 determines that the television network corresponding to the television network identifier in the remote-based command is not available to the STB 106 (block 520: NO), control advances to block 522 at which the communication interface 302 sends a failure notification to the ad-monitor automation cloud-based service 204 and the example instructions and/or operations 500 end. The failure notification is indicative that the television network identifier received in the remote-based command from the ad-monitor automation cloud-based service 204 corresponds to a television network that is not available to the STB 106.

However, if the verifier 308 determines that the television network is available to the STB 106 (block 520: YES), control advances to block 524 at which the communication interface 302 receives logged advertisement information from the STB 106. For example, the logged advertisement information (e.g., logged ad-monitoring information, ad impression logs) is based on the STB 106 accessing a television network (e.g., a television channel/stream) corresponding to the television network identifier in the STB command. At block 526, the verifier 308 and/or the log converter 306 access(es) the logged advertisement information generated by the STB 106.

At block 528, the log converter 306 converts the logged advertisement information to human-readable format. Alternatively, the converting of the logged advertisement information may be performed separately from the ad-monitor automation client 202 and/or at a later time. For example, the log conversion can be performed at a different location such as in the ad-monitor automation cloud-based service 204 or any STB 106. At block 530, the verifier 308 performs a verification process on the logged advertisement information. For example, the verifier 308 can perform verification operations of the logged advertisement information at the ad-monitor automation client 202 as described above. Through the verification operations, the verifier 308 identifies verified records of the logged advertisement information. In some examples, the verifier 308 also identifies unverifiable records of the logged advertisement information. The verifier 308 can generate an error report indicating a potential error or issue in the logged advertisement information based on the unverifiable records.

At block 532, the payload generator 310 adds the logged advertisement information and/or error report(s) to a payload to be sent to the ad-monitor automation cloud-based service 204. For example, the payload generator adds the logged advertisement information to one or more payload fields of one or more HTTP requests. At block 534, the communication interface 302 sends the logged advertisement information and/or error report(s) to the ad-monitor automation cloud-based service 204. For example, the communication interface 302 sends logged advertisement information and/or error report(s) in the payload(s) of one or more HTTP requests. The example instructions and/or operations 500 end.

FIG. 6 is a flowchart representative of example machine-readable instructions and/or example operations 600 that may be executed, instantiated, and/or performed by example programmable circuitry to implement the ad-monitor automation cloud-based service 204 of FIG. 4 to obtain ad-monitoring parameters from users via the GUI 208 and send remote-based commands to the ad-monitor automation client 202. The example machine-readable instructions and/or example operations 600 of FIG. 6 begin at block 602 at which the communication interface 402 receives a client registration request. For example, the communication interface 402 receives the client registration request from the ad-monitor automation client 202 which includes a request to register the ad-monitor automation client 202 and the STB 106 with the ad-monitor automation cloud-based service 204.

At block 604, the communication interface 402 receives health status information. For example, the communication interface 402 receives STB health status of the STB 106 and/or an automation client health status of the ad-monitor automation client 202 from the ad-monitor automation client 202. At block 606, the user interface controller 404 instantiates the GUI 208. At block 608, the user interface controller 404 receives user input from the GUI 208. For example, the user interface controller 404 receives ad-monitoring parameter values entered by a user via the GUI 208. At block 610, the user interface controller 404 accesses a television network identifier in the user input. For example, the user interface controller 404 accesses a television network identifier entered by the user. At block 612, the command generator 406 generates a remote-based command based on the television network identifier. For example, the command generator 406 includes a television network identifier and/or other ad-monitoring parameters in the remote-based command.

At block 614, the communication interface 402 sends the remote-based command to the automation client computer 101. For example, the communication interface 402 sends the remote-based command to the ad-monitor automation client 202 in the automation client computer 101. The remote-based command is to cause the automation client computer 101 to control the STB 106 to tune to a television network (e.g., a television channel/stream) corresponding to the television network identifier. At block 616 the ad-monitor automation cloud-based service 204 determines whether it has received a failure notification from the ad-monitor automation client 202. For example, a failure notification may be received by the communication interface 402 from the ad-monitor automation client 202 if the ad-monitor automation client 202 determines that the television identifier in the remote-based command corresponds to a television network that is not accessible by the STB 106.

If the ad-monitor automation cloud-based service 204 determines that a failure notification was received (block 616: YES), control advances to block 618 at which the user interface controller 404 displays a failure notification in the GUI 208. After the failure notification, control returns to block 608 at which the user interface controller 404 receives user input from the GUI 208 specifying another television network identifier of a television network to monitor. For example, blocks 608, 610, 612, 614, 616, and 618 can be performed iteratively until the user input specifies a television network identifier corresponding to a television network available to the STB 106.

If the ad-monitor automation cloud-based service 204 determines that a failure notification was not received (block 616: NO), control advances to block 620 at which the communication interface 402 receives logged advertisement information from the automation client computer 101. For example, the communication interface 402 receives logged advertisement information (e.g., logged ad-monitoring information, ad impression logs) from the ad-monitor automation client 202 of the automation client computer 101 based on logged advertisement information received by the ad-monitor automation client 202 from the STB 106. At block 622, the verifier 408 accesses the logged advertisement information. At block 624, the verifier 408 stores the logged advertisement information. For example, the verifier 408 can store the logged advertisement information in memory (e.g., the memory 716 of FIG. 7) and/or storage (e.g., the mass storage 728 of FIG. 7) for subsequent analysis and/or displaying via the GUI 208.

At block 626 the verifier 408 performs a verification process on the logged advertisement information. For example, the verifier 408 can perform verification operations of the logged advertisement information at the ad-monitor automation cloud-based service 204 as described above. At block 628, the verifier 408 determines whether any irregularity was detected in the logged advertisement information. If the verifier 408 determines that an irregularity was not detected (block 628: NO), the example instructions and/or operations 600 end. Otherwise, if the verifier 408 determines that an irregularity was detected (block 628: YES), control advances to block 630 at which the notification generator 410 generates a notification. Example notifications that can be sent by the notification generator 410 include notifications of nonstandard ads, repeated ads, insufficient ads, network issues, ad request parameter and/or impression failures, and/or any other suitable notifications. At block 632 the communication interface 402 sends the notification to one or more registered recipient(s). For example, the communication interface 402 can send notifications through a configurable notification service that supports multiple communication channels such as mailing services (e.g., email distribution lists), cloud-based collaboration platforms (e.g., Slack® software, Microsoft Teams® software, Google Chat® software), short message service (SMS), push notifications, and system dashboards. These notifications may be directed to one or more mailing group(s) of people involved with monitoring DAI ad insertion, as well as relevant stakeholders using any suitable communication methods. The example instructions and/or operations 600 of FIG. 6 end.

FIG. 7 is a block diagram of an example programmable circuitry platform 700 structured to execute and/or instantiate the example machine-readable instructions and/or the example operations of FIGS. 5A and 5B and/or FIG. 6 to implement the ad-monitor automation client 202 of FIG. 3 and/or the ad-monitor automation cloud-based service 204 of FIG. 4. The programmable circuitry platform 700 can be, for example, a server, a personal computer, a workstation, a self-learning machine (e.g., a neural network), a set-top-box, a television, or any other type of computing and/or electronic device. For example, a first programmable circuitry platform substantially similar or identical to the programmable circuitry platform 700 may be used to implement the ad-monitor automation client 202 and a second programmable circuitry platform substantially similar or identical to the programmable circuitry platform 700 may be used to implement the ad-monitor automation cloud-based service 204. In some examples, a third programmable circuitry platform substantially similar or identical to the programmable circuitry platform 700 may be used to implement the STB 106.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, XPUs, and/or microcontrollers from any desired family or manufacturer. The programmable circuitry 712 may be implemented by one or more semiconductor based (e.g., silicon based) devices. In examples in which the programmable circuitry platform 700 implements the ad-monitor automation client 202, the programmable circuitry 712 implements the command generator 304, the log converter 306, the verifier 308, and the payload generator 310 of FIG. 3. In examples in which the programmable circuitry 712 implements the ad-monitor automation cloud-based service 204, the programmable circuitry 712 implements the user interface controller 404, the command generator 406, the verifier 408, and the notification generator 410.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In examples in which the programmable circuitry platform 700 implements the ad-monitor automation client 202, the interface circuitry 720 implements the communication interface(s) 302 of FIG. 3. In examples in which the programmable circuitry platform 700 implements the ad-monitor automation cloud-based service 204, the interface circuitry 720 implements the communication interface 402 of FIG. 4.

The programmable circuitry platform 700 of the illustrated example also includes one or more mass storage discs or devices 728 to store firmware, software, and/or data. Examples of such mass storage discs or devices 728 include magnetic storage devices, optical storage devices, RAID systems, and/or solid-state storage discs or devices such as flash memory devices and/or SSDs.

The machine-readable instructions 732, which may be implemented by the machine-readable instructions of FIGS. 5A, 5B, and 6, may be stored in the mass storage device 728, in the volatile memory 714, in the non-volatile memory 716, and/or on at least one non-transitory computer readable storage medium which may be removable.

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

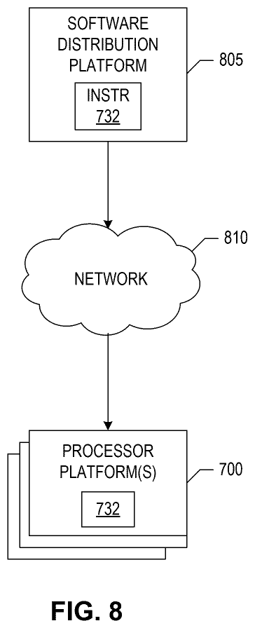

A block diagram illustrating an example software distribution platform 805 to distribute software such as the example machine-readable instructions 732 of FIG. 7 to other hardware devices (e.g., hardware devices owned and/or operated by third parties from the owner and/or operator of the software distribution platform) is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform 805. In the illustrated example, the software distribution platform 805 includes one or more servers and one or more storage devices. The storage devices store the machine-readable instructions 732, which may correspond to the example machine-readable instructions of FIGS. 5A, 5B, and 6, as described above. The one or more servers of the example software distribution platform 805 are in communication with an example network 810, which may correspond to any one or more of the Internet and/or any of the example networks described above. The servers enable downloading the machine-readable instructions 732 from the software distribution platform 805. Although referred to as software above, the distributed “software” could alternatively be firmware. “Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

As used herein “substantially real-time” refers to occurrence in a near instantaneous manner recognizing there may be real world delays for computing time, transmission, etc. Thus, unless otherwise specified, “substantially real-time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include any circuitry that can be programmed or configured to perform different operations and that includes one or more semiconductor-based logic devices (e.g., electrical hardware implemented by one or more transistors. Programmable circuitry may be: (i) one or more special purpose electrical circuits (e.g., an ASIC) and/or (ii) one or more general purpose semiconductor-based electrical circuits programmable with instructions. Examples of programmable circuitry include programmable microprocessors such as CPUs, FPGAs, GPUs, DSPs, XPUs, Network Processing Units (NPUs), and/or integrated circuits such as ASICs. For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing tasks to whichever one(s) of the multiple types of programmable circuitry is/are suited and available to perform the computing tasks.

From the foregoing, it will be appreciated that example systems, apparatus, articles of manufacture, and methods have been disclosed to monitor television advertising. Disclosed systems, apparatus, articles of manufacture, and methods improve a network-based media delivery system by monitoring advertisements presented in media streams and implementing a network-based feedback tool to generate alerts/notifications about ad-selection and/or ad-presentation issues. Disclosed systems, apparatus, articles of manufacture, and methods are accordingly directed to one or more improvement(s) in the operation of a machine such as a computer or other electronic device.

Example methods, apparatus, systems, and articles of manufacture to monitor television advertising are disclosed herein. Further examples and combinations thereof include the following:
Example 1 includes an apparatus comprising interface circuitry to communicate with a remote service and with a television media access client, machine-readable instructions, and programmable circuitry to be programmed by the machine-readable instructions to at least access a television network identifier in a first command from the remote service, cause the interface circuitry to send a second command to the television media access client, the second command to include the television network identifier, access logged advertisement information generated by the television media access client, the logged advertisement information based on the television media access client accessing a television network corresponding to the television network identifier, and after performing a verification process on the logged advertisement information, cause the interface circuitry to send the logged advertisement information to the remote service.
Example 2 includes the apparatus of example 1, wherein the interface circuitry is to send a client registration request to the remote service, and send a health status of the television media access client to the remote service.
Example 3 includes the apparatus of one or both of example 1 and/or example 2, wherein the logged advertisement information corresponds to an advertisement received by the television media access client via a first network and presented by the television media access client during a break in a media stream, the media stream received by the television media access client via a second network.
Example 4 includes the apparatus of any one or more of examples 1-3, wherein the programmable circuitry is to access a television channel number from a headend service based on the television network identifier and determine whether a television network corresponding to the television network identifier is available to the television media access client based on the television channel number.
Example 5 includes the apparatus of any one or more of examples 1-4, wherein to perform the verification process on the logged advertisement information, the programmable circuitry is to determine that the television network identifier is present in the logged advertisement information.
Example 6 includes the apparatus of example 1, wherein to perform the verification process on the logged advertisement information, the programmable circuitry is to determine that a device advertising identifier corresponding to the television media access client is present in the logged advertisement information.
Example 7 includes the apparatus of any one or more of examples 1-6, wherein to perform the verification process on the logged advertisement information, the programmable circuitry is to compare a first parameter value of an advertisement request logged in the logged advertisement information to a second parameter value of advertisement schedule information for dynamic advertisement insertion.
Example 8 includes a non-transitory machine-readable storage medium comprising instructions to cause programmable circuitry to at least access a television network identifier in a first command from a remote service, cause transmission of a second command to a television media access client, the second command to include the television network identifier, access logged advertisement information generated by the television media access client, the logged advertisement information representative of at least a first advertisement based on the television media access client accessing a television network corresponding to the television network identifier, and cause transmission of the logged advertisement information to the remote service after a determination that the logged advertisement information does not indicate presentation of a second advertisement via the television media access client after the television media access client tuned away from the television network during presentation of the at least the first advertisement.
Example 9 includes the non-transitory machine-readable storage medium of example 8, wherein the programmable circuitry is to access the television network identifier in the first command from the remote service after the programmable circuitry accesses a health status of the television media access client, and causes transmission of the health status of the television media access client to the remote service.
Example 10 includes the non-transitory machine-readable storage medium of one or both of example 8 and/or example 9, wherein the logged advertisement information corresponds to an advertisement received by the television media access client via a first network and presented by the television media access client during a break in a media stream, the media stream received by the television media access client via a second network.
Example 11 includes the non-transitory machine-readable storage medium of any one or more of examples 8-10, wherein the programmable circuitry is to cause communication with a headend service to determine a television channel number corresponding to the television network identifier; and determine whether the television media access client has access to a television network corresponding to the television network identifier based on metadata from the television media access client after the television media access client tunes to the television channel number.
Example 12 includes the non-transitory machine-readable storage medium of any one or more of examples 8-11, wherein the programmable circuitry is to cause the transmission of the logged advertisement information to the remote service after a determination that the logged advertisement information includes an indication of a live mode or a video-on-demand mode.
Example 13 includes the non-transitory machine-readable storage medium of any one or more of examples 8-12, wherein the programmable circuitry is to cause the transmission of the logged advertisement information to the remote service after a determination that a household identifier is located in the logged advertisement information.
Example 14 includes the non-transitory machine-readable storage medium of any one or more of examples 8-13, wherein the programmable circuitry is to cause the transmission of the logged advertisement information to the remote service after a comparison based on an advertisement request logged in the logged advertisement information and advertisement schedule information for dynamic advertisement insertion.
Example 15 includes a method comprising causing, by programmable circuitry programmed by at least one instruction, transmission of a command to a client computer, the command to include a television network identifier, the command to cause the client computer to control a television media access client to tune to a television network corresponding to the television network identifier, accessing, by the programmable circuitry, logged advertisement information from the client computer, the logged advertisement information generated by the television media access client based on the television media access client accessing a media stream from the television network, and determining, by the programmable circuitry, whether a break in the media stream designated for dynamic advertisement insertion was enabled for the dynamic advertisement insertion, the dynamic advertisement insertion corresponding to the television media access client presenting an advertisement selected after the television media access client accesses the media stream.
Example 16 includes the method of example 15, including, before the transmission of the command to the client computer receiving a request to register the client computer with a remote service, and receiving a health status of the television media access client from the client computer.
Example 17 includes the method of one or both of example 15 and/or example 16, including receiving user input via a remote graphical user interface, the user input indicative of the television network identifier.
Example 18 includes the method of any one or more of examples 15-17, including generating a notification after determining that the logged advertisement information is missing a logged impression confirmation corresponding to an advertisement request logged in the logged advertisement information.
Example 19 includes the method of any one or more of examples 15-18, wherein the television network is a first television network, the transmission of the command to the client computer is performed after receiving a failure notification from the client computer, the failure notification indicative that a previous television network identifier sent in a previous command to the client computer corresponds to a second television network that is not accessible by the television media access client.
Example 20 includes the method of any one or more of examples 15-19, including sending an alert to a recipient, the alert indicating that a fill rate of the break in the media stream was less than a duration of the break.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry to communicate with a remote service and with a television media access client;
machine-readable instructions; and
programmable circuitry to be programmed by the machine-readable instructions to at least:
access a television network identifier in a first command from the remote service;
cause the interface circuitry to send a second command to the television media access client, the second command to include the television network identifier;
access logged advertisement information generated by the television media access client, the logged advertisement information based on the television media access client accessing a television network corresponding to the television network identifier; and
after performing a verification process on the logged advertisement information, cause the interface circuitry to send the logged advertisement information to the remote service.

2. The apparatus of claim 1, wherein the interface circuitry is to:
send a client registration request to the remote service; and
send a health status of the television media access client to the remote service.

3. The apparatus of claim 1, wherein the logged advertisement information corresponds to an advertisement received by the television media access client via a first network and presented by the television media access client during a break in a media stream, the media stream received by the television media access client via a second network.

4. The apparatus of claim 1, wherein the programmable circuitry is to access a television channel number from a headend service based on the television network identifier and determine whether a television network corresponding to the television network identifier is available to the television media access client based on the television channel number.

5. The apparatus of claim 1, wherein to perform the verification process on the logged advertisement information, the programmable circuitry is to determine that the television network identifier is present in the logged advertisement information.

6. The apparatus of claim 1, wherein to perform the verification process on the logged advertisement information, the programmable circuitry is to determine that a device advertising identifier corresponding to the television media access client is present in the logged advertisement information.

7. The apparatus of claim 1, wherein to perform the verification process on the logged advertisement information, the programmable circuitry is to compare a first parameter value of an advertisement request logged in the logged advertisement information to a second parameter value of advertisement schedule information for dynamic advertisement insertion.

8. A non-transitory machine-readable storage medium comprising instructions to cause programmable circuitry to at least:
access a television network identifier in a first command from a remote service;
cause transmission of a second command to a television media access client, the second command to include the television network identifier;
access logged advertisement information generated by the television media access client, the logged advertisement information representative of at least a first advertisement based on the television media access client accessing a television network corresponding to the television network identifier; and
cause transmission of the logged advertisement information to the remote service after a determination that the logged advertisement information does not indicate presentation of a second advertisement via the television media access client after the television media access client tuned away from the television network during presentation of the at least the first advertisement.

9. The non-transitory machine-readable storage medium of claim 8, wherein the programmable circuitry is to access the television network identifier in the first command from the remote service after the programmable circuitry:
accesses a health status of the television media access client; and
causes transmission of the health status of the television media access client to the remote service.

10. The non-transitory machine-readable storage medium of claim 8, wherein the logged advertisement information corresponds to an advertisement received by the television media access client via a first network and presented by the television media access client during a break in a media stream, the media stream received by the television media access client via a second network.

11. The non-transitory machine-readable storage medium of claim 8, wherein the programmable circuitry is to:
cause communication with a headend service to determine a television channel number corresponding to the television network identifier; and
determine whether the television media access client has access to a television network corresponding to the television network identifier based on metadata from the television media access client after the television media access client tunes to the television channel number.

12. The non-transitory machine-readable storage medium of claim 8, wherein the programmable circuitry is to cause the transmission of the logged advertisement information to the remote service after a determination that the logged advertisement information includes an indication of a live mode or a video-on-demand mode.

13. The non-transitory machine-readable storage medium of claim 8, wherein the programmable circuitry is to cause the transmission of the logged advertisement information to the remote service after a determination that a household identifier is located in the logged advertisement information.

14. The non-transitory machine-readable storage medium of claim 8, wherein the programmable circuitry is to cause the transmission of the logged advertisement information to the remote service after a comparison based on an advertisement request logged in the logged advertisement information and advertisement schedule information for dynamic advertisement insertion.

15. A method comprising:
causing, by programmable circuitry programmed by at least one instruction, transmission of a command to a client computer, the command to include a television network identifier, the command to cause the client computer to control a television media access client to tune to a television network corresponding to the television network identifier;
accessing, by the programmable circuitry, logged advertisement information from the client computer, the logged advertisement information generated by the television media access client based on the television media access client accessing a media stream from the television network; and
determining, by the programmable circuitry, whether a break in the media stream designated for dynamic advertisement insertion was enabled for the dynamic advertisement insertion, the dynamic advertisement insertion corresponding to the television media access client presenting an advertisement selected after the television media access client accesses the media stream.

16. The method of claim 15, including, before the transmission of the command to the client computer:
receiving a request to register the client computer with a remote service; and
receiving a health status of the television media access client from the client computer.

17. The method of claim 15, including receiving user input via a remote graphical user interface, the user input indicative of the television network identifier.

18. The method of claim 15, including generating a notification after determining that the logged advertisement information is missing a logged impression confirmation corresponding to an advertisement request logged in the logged advertisement information.

19. The method of claim 15, wherein the television network is a first television network, the transmission of the command to the client computer is performed after receiving a failure notification from the client computer, the failure notification indicative that a previous television network identifier sent in a previous command to the client computer corresponds to a second television network that is not accessible by the television media access client.

20. The method of claim 15, including sending an alert to a recipient, the alert indicating that a fill rate of the break in the media stream was less than a duration of the break.
